(19) United States
(12) Patent Application Publication
(10) Pub. No.: US 2014/0147668 A1
(43) Pub. Date: May 29, 2014

(54) PRESSURE-SENSITIVE ADHESIVE COMPOSITION, PRESSURE-SENSITIVE ADHESIVE LAYER, PRESSURE-SENSITIVE ADHESIVE SHEET, SURFACE PROTECTIVE SHEET, OPTICAL SURFACE PROTECTIVE SHEET, AND OPTICAL FILM WITH SURFACE PROTECTIVE SHEET

(71) Applicant: NITTO DENKO CORPORATION, Osaka (JP)

(72) Inventors: Masato YAMAGATA, Osaka (JP); Masayuki OKAMOTO, Osaka (JP); Kiyoe SHIGETOMI, Osaka (JP); Ryo KANNO, Osaka (JP)

(73) Assignee: NITTO DENKO CORPORATION, Osaka (JP)

(21) Appl. No.: 14/171,199

(22) Filed: Feb. 3, 2014

Related U.S. Application Data
(63) Continuation of application No. PCT/JP2013/002247, filed on Apr. 1, 2013.

(30) Foreign Application Priority Data
Apr. 6, 2012 (JP) 2012-087981

(51) Int. Cl. C09J 7/02

(52) U.S. Cl. CPC C09J 7/0217
USPC 428/354; 524/265; 524/168; 428/355 AC

(57) ABSTRACT

A pressure-sensitive adhesive composition includes: 100 parts by mass of a polymer (A) having a glass transition temperature lower than 0° C.; 0.05 parts by mass to 3 parts by mass of a (meth)acrylic polymer (B) having a weight average molecular weight (MwB) of 1000≦MwB<30000 and including, as a monomer unit, a (meth)acrylic monomer having an alicyclic structure represented by the following general formula (1); 0.005 parts by mass to 1 part by mass of an ionic compound (C); and 0.01 parts by mass to 2.5 parts by mass of a compound (D) having a polyoxyalkylene chain.

CH₂═C(R¹)COOR² (1)
[wherein R¹ is a hydrogen atom or a methyl group and R² is an alicyclic hydrocarbon group having an alicyclic structure.]

### BACKGROUND OF THE INVENTION

1. Field of the Invention

The present invention relates to a pressure-sensitive adhesive composition having an antistatic property, a pressure-sensitive adhesive layer made of this pressure-sensitive adhesive composition, and a pressure-sensitive adhesive sheet, a surface protective sheet, an optical surface protective sheet, and an optical film with a surface protective sheet, the sheets and film being formed into a sheet shape, tape shape, or the like, by using the pressure-sensitive adhesive layer and having an antistatic property.

The pressure-sensitive adhesive sheet made of a pressure-sensitive adhesive composition having an antistatic property according to the present invention is preferably used in plastic products, etc., in which static electricity is likely to be caused. Among them, the pressure-sensitive adhesive sheet is particularly useful as both a pressure-sensitive adhesive sheet having an antistatic property to be used in the applications that do not like static electricity, such as electronic apparatuses, and a surface protective film to be used to protect the surfaces of optical members, such as a polarizing plate, a wavelength plate, an optical compensation film, and a reflective sheet.

2. Description of the Related Art

A surface protective film is used to prevent a scratch and a blot, which may be caused while an object to be protected is being processed or conveyed, by being attached to the object via a pressure-sensitive adhesive typically coated on the protective film side. For example, the panel of a liquid crystal display is formed by attaching an optical member, such as a polarizing plate, wavelength plate, or the like, to a liquid crystal cell via an adhesive. A protective film is attached, via an adhesive, to such an optical member to be attached to a liquid crystal cell in order to prevent a scratch and a blot, etc.

The protective film is peeled and removed in a stage where the protective film becomes unnecessary when the optical member is attached to the liquid crystal cell, etc. Because protective films and optical members are generally formed of plastic materials, they have high electric insulating properties and cause static electricity when they are rubbed or peeled. Accordingly, when a protective film is peeled from an optical member, such as a polarizing plate, static electricity is also caused. If a voltage is applied to a liquid crystal in a state where static electricity remains, the orientation of a liquid crystal molecule may be lost or a loss of a panel may be caused. Accordingly, in order to prevent such a failure, surface protective films are subjected to various antistatic treatments.

For example, a method of preventing static electricity is disclosed, in which one or more types of surfactants are added to a pressure-sensitive adhesive such that the surfactants are transferred to an adherend from the pressure-sensitive adhesive (see, for example, Patent Document 1). In this technique, however, the surfactants are likely to bleed to the surface of the pressure-sensitive adhesive, and hence there is the concern that the adherend may be contaminated when the pressure-sensitive adhesive is applied to a protective film. Accordingly, when a pressure-sensitive adhesive, to which a low-molecular surfactant has been added, is applied to a protective film for optical member, it is difficult to exhibit a sufficient antistatic property without impairing the optical characteristics of an optical member.

In addition, a method of suppressing bleeding of an antistatic agent to the surface of a pressure-sensitive adhesive is disclosed, in which an antistatic agent made of polyether polyol and an alkali metal salt is added to an acrylic pressure-sensitive adhesive (see, for example, Patent Document 2). In this method, however, bleeding of the antistatic agent cannot be avoided as well, and as a result, an adherend may be contaminated by a bleeding phenomenon, when a surface protective film, to which the pressure-sensitive adhesive has been actually applied, is subjected to a treatment at high temperature.

Further, a technique regarding an antistatic acrylic pressure-sensitive adhesive including both an acrylic copolymer having an alkylene oxide chain in its side chain and an ionic compound is disclosed (Patent Document 3), by which an antistatic property and a low contamination property are both intended to be achieved. In this method, however, there is the fear that a trouble, such lifting and unintended separation, or the like, may be caused.

As described above, surface protective films are peeled and removed when becoming unnecessary, and mostly they are peeled at relatively high speed from the viewpoint of work efficiency. Accordingly, there has been the problem that, if the pressure-sensitive adhesive force at high-speed peeling is large, work efficiency is decreased and an object to be protected, such as an optical member, glass, or the like, may be damaged when the film is peeled. On the other hand, when the pressure-sensitive adhesive force at high-speed peeling is intended to be made small, there has been the cases where a trouble, such as lifting and unintended separation, is caused after an object to be protected is punched or the end surface thereof is polished. In addition, when a surface protective film is used to protect the surface of an optical member, an adherend is sometimes inspected while the surface protective film is being attached, and therefore a surface protective film is required to have high transparency itself.

### PATENT DOCUMENTS

[Patent Document 1] Japanese Patent Application Publication No. 1997-165460
[Patent Document 2] Japanese Patent Application Publication No. 1994-128539
[Patent Document 3] Japanese Patent Application Publication No. 2005-206776

### SUMMARY OF THE INVENTION

Accordingly, in view of these situations, a purpose of the present invention is set to provide a pressure-sensitive adhesive composition excellent in transparency and a pressure-sensitive adhesive sheet and a surface protective film that use this pressure-sensitive adhesive composition and have an antistatic property, in which the pressure-sensitive adhesive composition has the characteristics described below: when an adherend not subjected to an antistatic treatment is peeled, prevention of the static electricity and suppression of a peeling-charged electrostatic potential can be achieved; the pressure-sensitive adhesive force at high-speed peeling is small; and the adhesive force at low-speed peeling is large to an extent in which a trouble, such as lifting and unintended separation, is not caused.

An aspect of the present invention is a pressure-sensitive adhesive composition. The pressure-sensitive adhesive composition comprises: 100 parts by mass of a polymer (A) having a glass transition temperature lower than 0° C.; 0.05 parts by mass to 3 parts by mass of a (meth)acrylic polymer (B) having a weight average molecular weight (MwB) of 1000≦MwB<30000 and including, as a monomer unit, a (meth)acrylic monomer having an alicyclic structure represented by the following general formula (1); 0.005 parts by mass to 1 part by mass of an ionic compound (C); and 0.01 parts by mass to 2.5 parts by mass of a compound (D) having a polyoxyalkylene chain.

CH₂═C(R¹)COOR² (1)

[wherein R¹ is a hydrogen atom or a methyl group and R² is an alicyclic hydrocarbon group having an alicyclic structure.]

In the pressure-sensitive adhesive composition according to the aspect, the polymer (A) may be a (meth)acrylic polymer (a).

In the pressure-sensitive adhesive composition according to the aspect, the alicyclic hydrocarbon group of the (meth)acrylic monomer having an alicyclic structure in the (meth)acrylic polymer (B) may have a bridged ring structure. In addition, the glass transition temperature of the (meth)acrylic polymer (B) may be 20° C. to 300° C.

In the pressure-sensitive adhesive composition according to the aspect, the ionic compound may be an alkali metal salt and/or an ionic liquid. In addition, the alkali metal salt may be a lithium salt.

In the pressure-sensitive adhesive composition according to the aspect, the ionic liquid may be any one of a nitrogen-containing onium salt, sulfur-containing onium salt, and phosphorus-containing onium salt.

In the pressure-sensitive adhesive composition according to the aspect, the ionic liquid may contain one or more types of cations represented by the following general formulae (C1) to (C4).

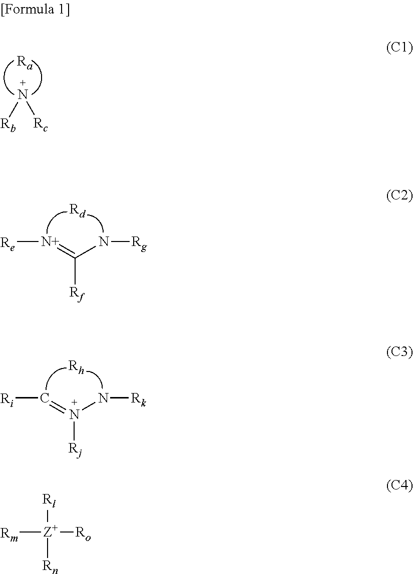

[In the formula (C1), Rₐ represents a C₄₋₂₀ hydrocarbon group and may include a hetero atom; each of R_{b} and Rₑ represents the same or different hydrogen or C₁₋₁₆ hydrocarbon group and may include a hetero atom. However, when the nitrogen atom includes a double bond, Rₑ is not present.]

[In the formula (C2), R_{d} represents a C₂₋₂₀ hydrocarbon group and may include a hetero atom; each of Rₑ, R_{f}, and R_{g} represents the same or different hydrogen or C₁₋₁₆ hydrocarbon group and may include a hetero atom.]

[In the formula (C3), Rₕ represents a C₂₋₂₀ hydrocarbon group and may include a hetero atom; each of Rᵢ, Rⱼ, and Rₖ represents the same or different hydrogen or C₁₋₁₆ hydrocarbon group and may include a hetero atom.]

[In the formula (C4), Z represents a nitrogen atom, sulfur atom, or phosphorus atom; each of Rₗ, Rₘ, Rₙ, and Rₒ represents the same or different C₁₋₂₀ hydrocarbon group and may include a hetero atom. However, when Z is a sulfur atom, Rₒ is not present.]

In the pressure-sensitive adhesive composition according to the aspect, the compound (D) having a polyoxyalkylene chain may be organopolysiloxane having a polyoxyalkylene chain represented by the following general formulae (D1) to (D3).

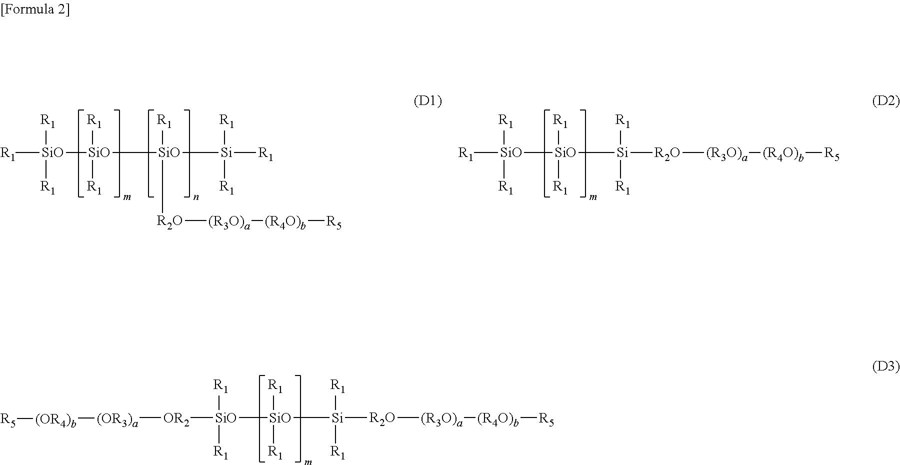

[In the formula (D1), R₁ is a monovalent organic group; each of R₂, R₃, and R₄ is an alkylene group; R₅ is a hydroxyl group or an organic group; each of m and n is an integer of 0 to 1000, however, m and n are not 0 at a time; and each of a and b is an integer of 0 to 1000, however, a and b are not 0 at a time.]

[In the formula (D2), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

[In the formula (D3), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

In the pressure-sensitive adhesive composition according to the aspect, the alicyclic hydrocarbon group of the (meth)acrylic monomer in the (meth)acrylic polymer (B) may have a bridged ring structure; the ionic compound (C) may be an ionic liquid; and the compound (D) having a polyoxyalkylene chain may be organopolysiloxane having a polyoxyalkylene chain.

In the pressure-sensitive adhesive composition according to the aspect, the (meth)acrylic polymer (a) may further include, as a monomer component, a hydroxyl group-containing (meth)acrylic monomer.

In the pressure-sensitive adhesive composition according to the aspect, the (meth)acrylic polymer (a) may further include, as a monomer component, an alkylene oxide group-containing reactive monomer whose average added mole number of oxyalkylene units is 3 to 40, in an amount of 5.0% by mass or less.

Another aspect of the present invention is a pressure-sensitive adhesive layer. The pressure-sensitive adhesive layer is made of the pressure-sensitive adhesive composition according to any one of the aforementioned aspects. The pressure-sensitive adhesive layer according to the aspect may include 85.00% by mass to 99.95% by mass of a solvent-insoluble component.

Still another aspect of the present invention is a pressure-sensitive adhesive sheet. The pressure-sensitive adhesive sheet includes the pressure-sensitive adhesive layer according to any one of the aforementioned aspects.

In the pressure-sensitive adhesive sheet according to the aspect, a supporting body may be a plastic substrate subjected to an antistatic treatment.

Still another aspect of the present invention is a surface protective sheet. The surface protective sheet includes the pressure-sensitive adhesive sheet according to any one of the aforementioned aspects.

The present invention further includes both an optical surface sheet in which the surface protective sheet is used to protect the surface of an optical film, and an optical film with a surface protective sheet in which the optical surface protective sheet is attached.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a side view explaining a low-speed peeling test (constant-load peeling);

FIG. 2 is a side view explaining a high-speed peeling test (180°-peeling pressure-sensitive adhesive force); and

FIG. 3 is a view explaining a peeling-charged electrostatic potential test.

### DETAILED DESCRIPTION OF THE INVENTION

The invention will now be described by reference to the preferred embodiments. This does not intend to limit the scope of the present invention, but to exemplify the invention.

A pressure-sensitive adhesive composition according to the present embodiment comprises: 100 parts by mass of a polymer (A) having a glass transition temperature lower than 0° C., as a pressure-sensitive adhesive composition; 0.05 parts by mass to 3 parts by mass of a (meth)acrylic polymer (B) having a weight average molecular weight (MwB) of 1000≦MwB<30000 and including, as a monomer unit, a (meth)acrylic monomer having an alicyclic structure represented by the following general formula (1) (hereinafter, appropriately referred to as a (meth)acrylic polymer (B)); 0.005 parts by mass to 1 part by mass of an ionic compound (C); and 0.01 parts by mass to 2.5 parts by mass of a compound (D) having a polyoxyalkylene chain.

CH₂═C(R¹)COOR² (1)

[wherein R¹ is a hydrogen atom or a methyl group and R² is an alicyclic hydrocarbon group having an alicyclic structure.]

Hereinafter, the polymer (A) and the (meth)acrylic polymer (B) will be described in detail.

### [Polymer (A)]

The polymer (A) is not particularly limited as far as the glass transition temperature of which is lower than 0° C., and various polymers to be generally used as a pressure-sensitive adhesive, such as an acrylic polymer, rubber polymer, silicone polymer, polyurethane polymer, and polyester polymer, etc., can be used. In particular, an acrylic polymer that is easily compatible with the (meth)acrylic polymer (B) and has high transparency is preferred.

The glass transition temperature (Tg) of the polymer (A) is lower than 0° C., preferably lower than −10° C., and more preferably lower than −40° C., and normally −80° C. or higher. If Tg of the polymer (A) is 0° C. or higher, it becomes difficult for the polymer to flow, and hence the wetting of an adherend becomes insufficient and the adhesiveness may be decreased.

The weight average molecular weight (MwA) of the polymer (A) is, for example, 30,000 to 5,000,000, preferably 100,000 to 2,000,000, and more preferably 200,000 to 1,000,000. If MwA<30,000, the cohesive force of the pressure-sensitive adhesive becomes insufficient, and hence the contamination to an adherend is sometimes likely to be caused. On the other hand, if MwA>5,000,000, the flowability of the pressure-sensitive adhesive becomes low, and hence the wetting of an adherend becomes insufficient and the adhesiveness may be decreased.

[(Meth)Acrylic Polymer (a)]

Hereinafter, a (meth)acrylic polymer (a), which is a preferred specific example of the Polymer (A), will be described in detail.

The (meth)acrylic polymer (a) is a polymer including, as a monomer unit, a (meth)acrylic acid alkyl ester having, for example, a C₁₋₂₀ linear or branched alkyl group in an amount of 50% by mass or more. Alternatively, the (meth)acrylic polymer (a) may have a structure that is formed by only a (meth)acrylic acid alkyl ester having a C₁₋₂₀ alkyl group or by a combination of two or more thereof. A method of obtaining the (meth)acrylic polymer (a) is not particularly limited, but the polymer can be obtained by adopting various polymerization methods that are generally used as a method of synthesizing an acrylic polymer, such as solution polymerization, emulsion polymerization, bulk polymerization, suspension polymerization, and radiation curing polymerization. When a peelable pressure-sensitive adhesive sheet according to the present embodiment is used as the later-described surface protective sheet, solution polymerization and emulsion polymerization can be preferably used.

The ratio of the (meth)acrylic acid alkyl ester having a C₁₋₂₀ alkyl group is 50% by mass to 99.9% by mass, preferably 60% by mass to 98% by mass, and more preferably 70% by mass to 95% by mass, based on the total mass of the monomer components for preparing the (meth)acrylic polymer (a).

Examples of the (meth)acrylic acid alkyl ester having a C₁₋₂₀ alkyl group include, for example: (meth)acrylic acid C₁₋₂₀ alkyl esters [preferably (meth)acrylic acid C₂₋₁₄ alkyl esters, and more preferably (meth)acrylic acid C₂₋₁₀ alkyl esters], such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl. Herein, the (meth)acrylic acid alkyl ester means an acrylic acid alkyl ester and/or a methacrylic acid alkyl ester, and all of the “(meth) . . . ” expressions have the same meaning.

For the purpose of modifying cohesive force, heat resistance, and cross-linking property, etc., the (meth)acrylic polymer (a) may include, if necessary, another monomer component (copolymerizable monomer) that is copolymerizable with the (meth)acrylic acid alkyl ester. Accordingly, the acrylic polymer may include a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as an acrylic acid, methacrylic acid, carboxy ethyl acrylate, carboxypentyl acrylate, itaconic acid, maleic acid, fumaric acid, crotonic acid, and isocrotonic acid; hydroxyl group-containing monomers, such as (meth)acrylic acid hydroxyalkyls including (meth)acrylic acid 2-hydroxyethyl, (meth)acrylic acid 3-hydroxypropyl, (meth)acrylic acid 4-hydroxybutyl, (meth)acrylic acid 6-hydroxyhexyl, (meth)acrylic acid 8-hydroxyoctyl, (meth)acrylic acid 10-hydroxydecyl, (meth)acrylic acid 12-hydroxy lauryl, and (4-hydroxymethyl cyclohexyl)methyl methacrylate; acid anhydride group-containing monomers, such as maleic acid anhydride and itaconic acid anhydride; sulfonic acid group-containing monomers, such as styrenesulfonic acid, allylsulfonic acid, 2-(meth)acrylamide-2-methylpropanesulfonic acid, (meth)acrylamide propanesulfonic acid, sulfopropyl(meth)acrylate, and (meth)acryloyloxy naphthalenesulfonic acid; phosphoric acid group-containing monomers, such as 2-hydroxyethyl acryloyl phosphate; (N-substituted) amide monomers, such as (meth)acrylamide, N,N-dialkyl(meth)acrylamides including N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide, etc., N-ethyl(meth)acrylamide, N-isopropyl(meth)acrylamide, N-butyl(meth)acrylamide, N-n-butyl(meth)acrylamide, N-methylol(meth)acrylamide, N-ethylol(meth)acrylamide, N-methylol propane(meth)acrylamide, N-methoxymethyl(meth)acrylamide, N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexyl maleimide, N-isopropylmaleimide, N-lauryl maleimide, and N-phenyl maleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; vinyl esters, such as vinyl acetate and vinyl propionate; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloyl pyrrolidine, N-vinyl morpholine, N-vinyl-2-piperidone, N-vinyl-3-morpholinone, N-vinyl-2-caprolactam, N-vinyl-1,3-oxazine-2-one, N-vinyl-3,5-morpholinedione, N-vinyl pyrazole, N-vinyl isoxazole, N-vinyl thiazole, N-vinyl isothiazole, and N-vinyl pyridazine; N-vinyl carboxylic acid amides; lactam monomers, such as N-vinyl caprolactam; cyano-containing monomers, such as acrylonitrile and methacrylonitrile; and (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; styrene monomers, such as styrene and α-methylstyrene; epoxy group-containing acrylic monomers, such as (meth)acrylic acid glycidyl; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; vinyl esters, such as vinyl acetate and vinyl propionate; aromatic vinyl compounds, such as vinyl toluene and styrene; olefins or dienes, such as ethylene, butadiene, isoprene, and isobutylene; vinyl ethers, such as vinyl alkyl ether; vinyl chloride; sulfonic acid group-containing monomers, such as vinyl sulfonate sodium; imide group-containing monomers, such as cyclohexyl maleimide and isopropyl maleimide; isocyanate group-containing monomers, such as 2-isocyanate ethyl(meth)acrylate; acryloyl morpholine; (meth)acrylic acid esters having an alicyclic hydrocarbon group, such as cyclopentyl(meth)acrylate, cyclohexyl(meth)acrylate, isobornyl(meth)acrylate, and dicyclopentanyl(meth)acrylate; (meth)acrylic acid esters having an aromatic hydrocarbon group, such as phenyl(meth)acrylate and phenoxyethyl(meth)acrylate; and (meth)acrylic acid esters obtained from terpene compound derivative alcohols, etc. These copolymerizable monomers can be used alone or in combination of two or more thereof.

When the (meth)acrylic polymer (a) includes a copolymerizable monomer along with a (meth)acrylic acid alkyl ester as a major component, a hydroxyl group-containing monomer or a carboxyl group-containing monomer can be preferably used. Among them, (meth)acrylic acid 2-hydroxyethyl or (meth)acrylic acid 4-hydroxybutyl can be preferably used as the hydroxyl group-containing monomer, and an acrylic acid can be preferably used as the carboxyl group-containing monomer. The use amount of the copolymerizable monomer is not particularly limited, but the copolymerizable monomer can be typically included in an amount of 0.01% by mass to 40% by mass, preferably 0.1% by mass to 30% by mass, and more preferably 0.5% by mass to 20% by mass, based on the total mass of the monomer components for preparing the acrylic polymer.

By including 0.01% by mass or more of the copolymerizable monomer, a decrease in the cohesive force of the acrylic pressure-sensitive adhesive sheet having the pressure-sensitive adhesive layer formed by the acrylic pressure-sensitive adhesive composition can be prevented, and the contamination to an adherend, possibly occurring when peeled from the adherend, can be prevented. Further, by including the copolymerizable monomer in an amount of 40% by mass or less, it can be prevented that the cohesive force thereof may become too large and the tackiness at normal temperature (25° C.) can be improved.

In the pressure-sensitive adhesive composition according to the present embodiment, the (meth)acrylic polymer (a) may further include, as a monomer component, an alkylene oxide group-containing reactive monomer whose average added mole number of oxyalkylene units is 3 to 40, in an amount of 5.0% by mass or less.

The average added mole number of oxyalkylene units in the alkylene oxide group-containing reactive monomer is preferably 3 to 40, more preferably 4 to 35, and particularly preferably 5 to 30, from the viewpoint of the compatibility with the ionic compound. When the average added mole number is 3 or more, there is the tendency that an effect of reducing the termination of an adherend can be efficiently acquired. If the average added mole number is more than 40, the interaction with the ionic compound becomes large, and there is the tendency that coating of the pressure-sensitive adhesive composition becomes difficult because the composition is in a gel form, which is not preferable. Herein, the end of the oxyalkylene chain may be an hydroxyl group as is, or may be replaced by another functional group, etc.

The alkylene oxide group-containing reactive monomer may be used alone or in combination of two or more thereof. The content thereof as a whole is preferably 5.0% by mass or less, more preferably 4.0% by mass or less, particularly preferably 3.0% by mass or less, and still more preferably 1.0% by mass or less, based on the total mass of the monomer components for preparing the (meth)acrylic polymer (a). If the content of the alkylene oxide group-containing reactive monomer is more than 5.0% by mass, the interaction with the ionic compound becomes large, and hence ion conduction is hampered and the antistatic property is decreased, which is not preferable.

Examples of the oxyalkylene unit of the alkylene oxide group-containing reactive monomer include those having a C₁₋₆ alkylene group, such as, for example, an oxymethylene group, oxyethylene group, oxypropylene group, and oxybutylene group. The hydrocarbon groups in the oxyalkylene chain may be linear or branched.

In addition, It is preferable that the alkylene oxide group-containing reactive monomer is one having an ethylene oxide group. By using, as a base polymer, the (meth)acrylic polymer including the reactive monomer having an ethylene oxide group, the compatibility between the base polymer and the ionic compound is improved and the bleed to an adherend can be preferably suppressed, thereby allowing a pressure-sensitive adhesive composition having a low contamination property to be obtained.

Examples of the alkylene oxide group-containing reactive monomer to be used in the present embodiment include, for example, a (meth)acrylic acid alkylene oxide adduct and reactive surfactants having, in its molecule, a reactive substituent group, such as an acryloyl group, methacryloyl group, allyl group, or the like.

Specific examples of the (meth)acrylic acid alkylene oxide adduct include, for example, polyethylene glycol(meth)acrylate, (poly)propylene glycol(meth)acrylate, polyethylene glycol-polypropylene glycol(meth)acrylate, polyethylene glycol-polybutylene glycol(meth)acrylate, polypropylene glycol-polybutylene glycol(meth)acrylate, methoxypolyethylene glycol(meth)acrylate, ethoxypolyethylene glycol (meth)acrylate, butoxypolyethylene glycol (meth)acrylate, octoxypolyethylene glycol(meth)acrylate, lauroxypolyethylene glycol(meth)acrylate, stearoxypolyethylene glycol (meth)acrylate, phenoxypolyethylene glycol (meth)acrylate, methoxypolypropylene glycol(meth)acrylate, octoxypolyethylene glycol-polypropylene glycol(meth)acrylate, etc.

Specific examples of the reactive surfactants include an anionic reactive surfactant, nonionic surfactant, and cationic reactive surfactant, all of which have, for example, a (meth)acryloyl group or an allyl group.

Examples of the anionic reactive surfactant include, for example, surfactants represented by the formulae (A1) to (A10).

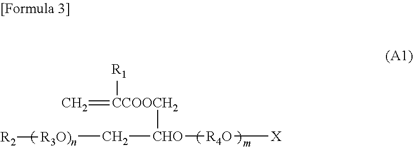

[In the formula (A1), R₁ represents hydrogen or a methyl group; R₂ represents a C₁₋₃₀ hydrocarbon group or an acyl group; x represents an anionic hydrophilic group; each of R₃ and R₄ represents the same or different C₁₋₆ alkylene group; and average added mole number of each of m and n is 0 to 40, however, (m+n) represents the number of 3 to 40.]

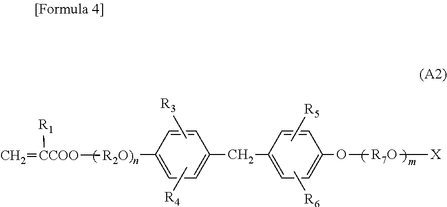

[In the formula (A2), R₁ represents hydrogen or a methyl group; each of R₂ and R₇ represents the same or different C₁₋₆ alkylene group; each of R₃ and R₅ represents the same or different hydrogen or alkyl group; each of R₄ and R₆ represents the same or different hydrogen, alkyl group, benzyl group, or styrene group; x represents an anionic hydrophilic group; and average added mole number of each of m and n is 0 to 40, however, (m+n) represents the number of 3 to 40.]

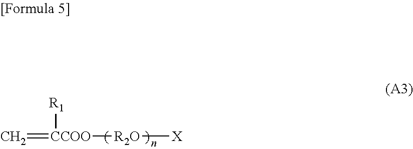

[In the formula (A3), R₁ represents hydrogen or a methyl group; R₂ represents a C₁₋₆ alkylene group; x represents an anionic hydrophilic group; and average added mole number of n represents the number of 3 to 40.]

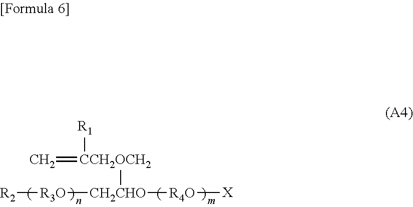

[In the formula (A4), R₁ represents hydrogen or a methyl group; R₂ represents a C₁₋₃₀ hydrocarbon group or an acyl group; each of R₃ and R₄ represents the same or different C₁₋₆ alkylene group; x represents an anionic hydrophilic group; and average added mole number of each of m and n represents the number of 0 to 40, however, (m+n) represents the number of 3 to 40.]

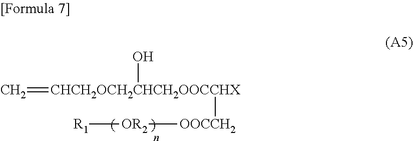

[In the formula (A5), R₁ represents a hydrocarbon group, amino group or carboxylate residue; R₂ represents a C₁₋₆ alkylene group; x represents an anionic hydrophilic group; and average added mole number of n represents an integer of 3 to 40.]

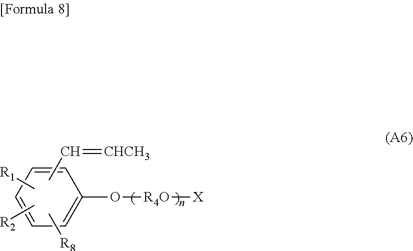

[In the formula (A6), R₁ represents a C₁₋₃₀ hydrocarbon group; R₂ represents hydrogen or a C₁₋₃₀ hydrocarbon group; R₃ represents hydrogen or a propenyl group; R₄ represents a C₁₋₆ alkylene group; x represents an anionic hydrophilic group; and average added mole number of n represents the number of 3 to 40.]

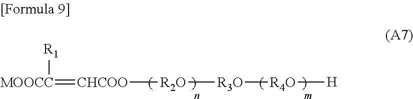

[In the formula (A7), R₁ represents hydrogen or a methyl group; each of R₂ and R₄ represents the same or different C₁₋₆ alkylene group; R₃ represents a C₁₋₃₀ hydrocarbon group; M represents hydrogen, an alkali metal, ammonium group, or alkanol ammonium group; and average added mole number of each of m and n represents the number of 0 to 40, however, (m+n) represents the number of 3 to 40.]

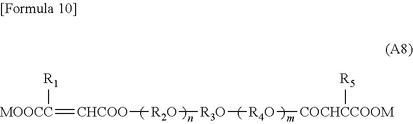

[In the formula (A8), each of R₁ and R₅ represents the same or different hydrogen or methyl group; each of R₂ and R₄ represents the same or different C₁₋₆ alkylene group; R₃ represents a C₁₋₃₀ hydrocarbon group; M represents hydrogen, an alkali metal, ammonium group, or alkanol ammonium group; and average added mole number of each of m and n represents the number of 0 to 40, however (m+n) represents the number of 3 to 40.]

[Formula 11]

MOOCCH═CHCOOR₁OₙR₂ (A9)

[In the formula (A9), R₁ represents a C₁₋₆ alkylene group; R₂ represents a C₁₋₃₀ hydrocarbon group; M represents hydrogen, an alkali metal, ammonium group, or alkanol ammonium group; and average added mole number of n represents the number of 3 to 40.]

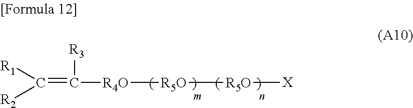

[In the formula (A10), each of R₁, R₂, and R₃ represents the same or different hydrogen or methyl group; R₄ represents a C₀₋₃₀ hydrocarbon group (when the number of carbons is 0, it indicates that R₄ is not present); each of R₅ and R₆ represents the same or different C₁₋₆ alkylene group; x represents an anionic hydrophilic group; and average added mole number of each of m and n represents the number of 0 to 40, however (m+n) represents the number of 3 to 40.]

In the above formulae (A1) to (A6) and (A10), x represents an anionic hydrophilic group. Examples of the anionic hydrophilic group include ones represented by the following formulae (a1) and (a2).

[Formula 13]

—SO₃M₁ (a1)

[wherein M₁ represents hydrogen, an alkali metal, ammonium group, or alkanol ammonium group.]

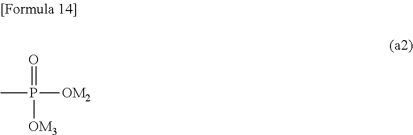

[wherein each of M₂ and M₃ represents the same or different hydrogen, alkali metal, ammonium group, or alkanol ammonium group.]

Examples of the nonionic reactive surfactant include, for example, ones represented by the formulae (N1) to (N6).

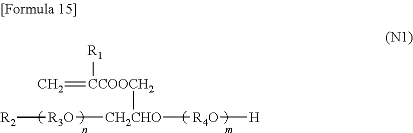

[wherein R₁ represents hydrogen or a methyl group; R₂ represents a C₁₋₃₀ hydrocarbon group or acyl group; each of R₃ and R₄ represents the same or different C₁₋₆ alkylene group; and average added mole number of each of m and n represents the number of 0 to 40, however (m+n) represents the number of 3 to 40.]

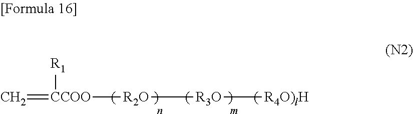

[wherein R₁ represents hydrogen or a methyl group; each of R₂, R₃, and R₄ represents the same or different C₁₋₆ alkylene group; and average added mole number of each of n and m represents the number of 0 to 40, and (n+m+1) represents the number of 3 to 40.]

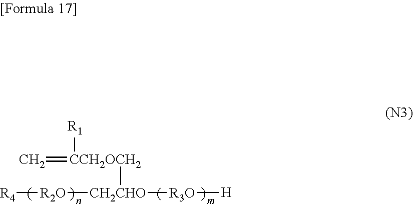

[wherein R₁ represents hydrogen or a methyl group; each of R₂ and R₃ represents the same or different C₁₋₆ alkylene group; R₄ represents a C₁₋₃₀ hydrocarbon group or acyl group; and average added mole number of each of m and n represents the number of 0 to 40, however (m+n) represents the number of 3 to 40.]

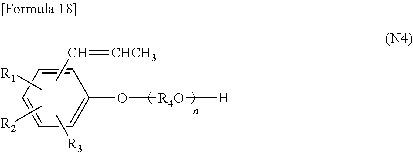

[wherein each of R₁ and R₂ represents the same or different C₁₋₃₀ hydrocarbon group; R₃ represents hydrogen or a propenyl group; R₄ represents a C₁₋₆ alkylene group; and average added mole number of n represents the number of 3 to 40.]

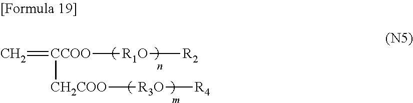

[wherein each of R₁ and R₃ represents the same or different C₁₋₆ alkylene group; each of R₂ and R₄ represents the same or different hydrogen, C₁₋₃₀ hydrocarbon group, or acyl group; and average added mole number of each of m and n represents the number of 0 to 40, however (m+n) represents the number of 3 to 40.]

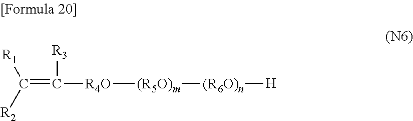

[wherein each of R₁, R₂, and R₃ represents the same or different hydrogen or methyl group; R₄ represents a C₀₋₃₀ hydrocarbon group (when the number of carbons is 0, it indicates that R₄ is not present); each of R₅ and R₆ represents the same or different C₁₋₆ alkylene group; and average added mole number of each of m and n represents the number of 0 to 40, however (m+n) represents the number of 3 to 40.]

Specific examples of commercial products of the alkylene oxide group-containing reactive monomer include, for example, BLEMMER PME-400, BLEMMER PME-1000, BLEMMER 50POEP-800B (these are made by NOF CORPORATION), LAMUTEL PD-420, LAMUTEL PD-430 (these are made by Kao Corporation), Adekaria Soap ER-10, and Adekaria Soap NE-10 (these are made by ADEKA CORPORATION), etc.

The (meth)acrylic polymer (a) may also include, if necessary, a polyfunctional monomer, in order to adjust the cohesive force of the acrylic pressure-sensitive adhesive composition to be formed.

Examples of the polyfunctional monomer include, for example, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecanediol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, and 1,4-butanediol diacrylate, etc. Among them, trimethylolpropane tri(meth)acrylate, 1,6-hexanediol di(meth)acrylate, and dipentaerythritol hexa(meth)acrylate can be preferably used. The polyfunctional (meth)acrylates can be used alone or in combination of two or more thereof.

The use amount of the polyfunctional monomer is changed depending on the molecular weight or the number of functional groups thereof. Herein, the polyfunctional monomer is added in an amount of 0.01% by mass to 3.0% by mass, preferably 0.02% by mass to 2.0% by mass, and more preferably 0.03% by mass to 1.0% by mass, based on the total mass of the monomer components for preparing the (meth)acrylic polymer (a).

If the use amount of the polyfunctional monomer is more than 3.0% by mass based on the total mass of the monomer components for preparing the (meth)acrylic polymer (a), for example, the cohesive force of the acrylic pressure-sensitive adhesive composition may become too large and accordingly the adhesive force (high-speed peeling force, low-speed peeling force) may be decreased. On the other hand, if the use amount thereof is less than 0.01% by mass, the cohesive force of an acrylic pressure-sensitive adhesive composition is decreased, and accordingly an adherend (object to be protected) may be contaminated when a sheet is peeled from the adherend.

In preparing the (meth)acrylic polymer (a), the acrylic polymer can be easily formed by a curing reaction using heat or ultraviolet rays with the use of a polymerization initiator, such as a thermal polymerization initiator, photo-polymerization initiator (photo-initiator), or the like. In particular, a thermal polymerization initiator can be preferably used in terms of the advantage that a polymerization time can be shortened. The polymerization initiators can be used alone or in combination of two or more thereof.

Examples of the thermal polymerization initiator include, for example, azo polymerization initiators (e.g., 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl) propane]dihydrochloride, 2,2′-azobis(2-methylpropionamidine)disulfate, and 2,2′-azobis(N,N′-dimethyleneisobutylamidine)dihydrochloride, etc.); peroxide polymerization initiators (e.g., dibenzoyl peroxide, t-butyl permaleate, and lauroyl peroxide, etc.); and redox polymerization initiators, etc.

The use amount of the thermal polymerization initiator is not particularly limited, but the thermal polymerization initiator is combined, for example, in an amount of 0.01 parts by mass to 5 parts by mass, and preferably 0.05 parts by mass to 3 parts by mass, based on 100 parts by mass of the monomer components for preparing the (meth)acrylic polymer (a).

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one [product name: IRGACURE 651, made by BASF], and anisoin, etc. Specific examples of the acetophenone photo-polymerization initiator include, for example: 1-hydroxycyclohexyl phenyl ketone [product name: IRGACURE 184, made by BASF], 4-phenoxy dichloroacetophenone, 4-t-butyl-dichloroacetophenone, 1-[4-(2-hydroxyethoxy)-phenyl]-2-hydroxy-2-methyl-1-propane-1-one [product name: IRGACURE 2959, made by BASF], 2-hydroxy-2-methyl-1-phenyl-propane-1-one [product name: DAROCUR 1173, made by BASF], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,2-propanedione-2-(O-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Specific examples of the thioxanthone photo-polymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Specific examples of the acylphosphine photo-polymerization initiator include, for example: bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methypropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

The use amount of the photo-polymerization initiator is not particularly limited, but the photo-polymerization initiator is combined, for example, in an amount of 0.01 parts by mass to 5 parts by mass, and preferably 0.05 parts by mass to 3 parts by mass, based on 100 parts by mass of the monomer components for preparing the (meth)acrylic polymer (a).

If the use amount of the photo-polymerization initiator is less than 0.01 parts by mass, a polymerization reaction may become insufficient. If the use amount thereof is more than 5 parts by mass, an ultraviolet ray may not reach the inside of the pressure-sensitive adhesive layer, because the photo-polymerization initiator absorbs an ultraviolet ray. In this case, a decrease in the rate of polymerization is caused, or the molecular weight of the generated polymer becomes small. Thereby, the cohesive force of the pressure-sensitive adhesive layer to be formed becomes small, and hence, when the pressure-sensitive adhesive layer is peeled from a film, part of the layer may remain on the film and the film cannot be reused. The photo-polymerization initiators may be used alone or in combination of two or more thereof.

In the present embodiment, the (meth)acrylic polymer (a) can also be prepared as a partial polymer (acrylic polymer syrup) that can be obtained by radiating ultraviolet (UV) rays onto a mixture in which the aforementioned monomer components and the polymerization initiator have been combined, so that the monomer components are partially polymerized. An acrylic pressure-sensitive adhesive composition is prepared by combining the later-described (meth)acrylic polymer (B) into the acrylic polymer syrup, and then polymerization can also be completed by coating the pressure-sensitive adhesive composition on a predetermined object to be coated and by radiating UV rays.

The weight average molecular weight (Mw(a)) of the (meth)acrylic polymer (a) is, for example, 30,000 to 5,000,000, preferably 100,000 to 2,000,000, and more preferably 200,000 to 1,000,000. If Mw(a) is too smaller than the above range, the cohesive force of the pressure-sensitive adhesive becomes insufficient and the contamination to an adherend is sometimes likely to be caused. On the other hand, if Mw(a) is too larger than the above range, the flowability of the pressure-sensitive adhesive becomes low, and hence the wetting of an adherend becomes insufficient and the adhesiveness may be decreased.

The glass transition temperature (Tg) of the (meth)acrylic polymer (a) is lower than 0° C., preferably lower than −10° C., and more preferably lower than −40° C., and normally −80° C. or higher. If Tg of the (meth)acrylic polymer (a) is 0° C. or higher, it becomes difficult for the polymer to flow, and hence the wetting of an adherend becomes insufficient and the adhesiveness may be decreased.

### [(Meth)Acrylic Polymer (B)]

The (meth)acrylic polymer (B) is a (meth)acrylic polymer having a weight average molecular weight (MwB) of 1000≦MwB<30000 and including, as a monomer unit, a (meth)acrylic monomer having an alicyclic structure represented by the following general formula (1), and functions as a tackifying resin in the peelable acrylic pressure-sensitive adhesive composition according to the present embodiment.

CH₂═C(R¹)COOR² (1)

[wherein R¹ is a hydrogen atom or a methyl group and R² is an alicyclic hydrocarbon group having an alicyclic structure.]

Examples of the alicyclic hydrocarbon group R² in the general formula (1) include alicyclic hydrocarbon groups, such as a cyclohexyl group, isobornyl group, and dicyclopentanyl group, etc. Examples of the (meth)acrylic acid ester having such an alicyclic hydrocarbon group include esters with alicycle alcohols of (meth)acrylic acids, such as, for example, (meth)acrylic acid cyclohexyl having a cyclohexyl group, (meth)acrylic acid isobornyl having an isobornyl group, and (meth)acrylic acid dicyclopentanyl having a dicyclopentanyl group. Thus, by providing, as a monomer unit, a (meth)acrylic monomer having a relatively bulky structure to the (meth)acrylic polymer (B), the adhesiveness at low-speed peeling can be improved.

In the present embodiment, it is further desirable that the alicyclic hydrocarbon group, which forms the (meth)acrylic polymer (B), has a bridged ring structure. The bridged ring structure refers to an alicyclic structure of three or more rings. By providing a bulky structure, such as a bridged ring structure, to the (meth)acrylic polymer (B), the adhesiveness of the peelable acrylic pressure-sensitive adhesive composition (peelable acrylic pressure-sensitive adhesive sheet) can be further improved. In particular, the adhesiveness at low-speed peeling can be remarkably improved.

Examples of the R², which is an alicyclic hydrocarbon group having a bridged ring structure, include, for example: a dicyclopentanyl group represented by the following formula (3a); a dicyclopentenyl group represented by the following formula (3b); an adamantyl group represented by the following formula (3c); a tricyclopentanyl group represented by the following formula (3d); and a tricyclopentenyl group represented by the following formula (3e), etc. When UV polymerization is adopted in synthesizing the (meth)acrylic polymer (B) or in producing the pressure-sensitive adhesive composition, a (meth)acrylic monomer having a saturated structure, such as a dicyclopentanyl group represented by the following formula (3a), an adamantyl group represented by the following formula (3c), and a tricyclopentanyl group represented by the following formula (3d), can be particularly and preferably used, of the (meth)acrylic monomers having an alicyclic structure of three or more rings and having a bridged ring structure, as a monomer that forms the (meth)acrylic polymer (B).

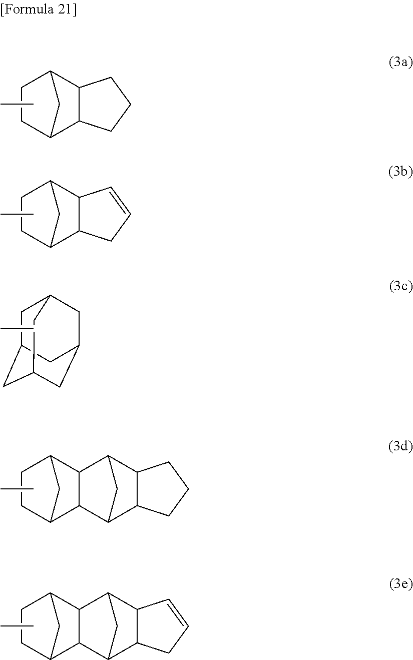

Examples of such a (meth)acrylic monomer having an alicyclic structure of three or more rings and having a bridged ring structure include (meth)acrylic acid esters, such as dicyclopentanyl methacrylate, dicyclopentanyl acrylate, dicyclopentanyl oxyethyl methacrylate, dicyclopentanyl oxyethyl acrylate, tricyclopentanyl methacrylate, tricyclopentanyl acrylate, 1-adamantyl methacrylate, 1-adamantyl acrylate, 2-methyl-2-adamantyl methacrylate, 2-methyl-2-adamantyl acrylate, 2-ethyl-2-adamantyl methacrylate, and 2-ethyl-2-adamantyl acrylate. This (meth)acrylic monomer can be used alone or in combination of two or more thereof.

The (meth)acrylic polymer (B) according to the present embodiment may be a homopolymer formed of a (meth)acrylic monomer having an alicyclic structure, or may be a copolymer formed of both a (meth)acrylic monomer having an alicyclic structure and another (meth)acrylic acid ester monomer or a copolymerizable monomer.

Examples of such a (meth)acrylic acid ester monomer include: (meth)acrylic acid alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid-2-ethylhexyl, (meth)acrylic acid heptyl, (meth)acrylic acid octyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, and (meth)acrylic acid dodecyl; (meth)acrylic acid aryl esters, such as (meth)acrylic acid phenyl and (meth)acrylic acid benzyl; and (meth)acrylic acid esters obtained from terpene compound derivative alcohols, etc. These (meth)acrylic acid esters can be used alone or in combination of two or more thereof.

Alternatively, the (meth)acrylic polymer (B) can also be obtained by copolymerizing another monomer component (copolymerizable monomer) that is copolymerizable with the (meth)acrylic acid ester, in addition to the aforementioned (meth)acrylic acid ester component unit.

Examples of the another monomer that is copolymerizable with the (meth)acrylic acid ester include: carboxyl group-containing monomers, such as acrylic acid, methacrylic acid, carboxy ethyl acrylate, carboxypentyl acrylate, itaconic acid, maleic acid, fumaric acid, crotonic acid, and isocrotonic acid; (meth)acrylic acid alkoxy alkyl monomers, such as (meth)acrylic acid methoxyethyl, (meth)acrylic acid ethoxyethyl, (meth)acrylic acid propoxyethyl, (meth)acrylic acid butoxyethyl, and (meth)acrylic acid ethoxypropyl; salts, such as (meth)acrylic acid alkali metal salt; di(meth)acrylic acid ester monomers of (poly)alkylene glycols, such as di(meth)acrylic acid ester of ethylene glycol, di(meth)acrylic acid ester of diethylene glycol, di(meth)acrylic acid ester of triethylene glycol, di(meth)acrylic acid ester of polyethylene glycol, di(meth)acrylic acid ester of propylene glycol, di(meth)acrylic acid ester of dipropylene glycol, and di(meth)acrylic acid ester of tripropylene glycol; poly(meth)acrylic acid ester monomers, such as trimethylolpropane tri(meth)acrylic acid ester; vinyl esters, such as vinyl acetate and vinyl propionate; halogenated vinyl compounds, such as vinylidene chloride and (meth)acrylic acid-2-chloroethyl; oxazoline group-containing polymerizable compounds, such as 2-vinyl-2-oxazoline, 2-vinyl-5-methyl-2-oxazoline, and 2-isopropenyl-2-oxazoline; aziridine group-containing polymerizable compounds, such as (meth)acryloylaziridine and (meth)acrylic acid-2-aziridinylethyl; epoxy group-containing vinyl monomers, such as allyl glycidyl ether, (meth)acrylic acid glycidyl ether, and (meth)acrylic acid-2-ethyl glycidyl ether; hydroxyl group-containing vinyl monomers, such as (meth)acrylic acid-2-hydroxyethyl, (meth)acrylic acid-2-hydroxypropyl, and adducts of lactones and (meth)acrylic acid-2-hydroxyethyl; macro-monomers in which an unsaturated group, such as (meth)acryl group, styryl group, vinyl group, or the like, is bonded to the ends of polyalkylene glycols, such as polypropylene glycol, polyethylene glycol, polytetramethylene glycol, polybutylene glycol, copolymer of polyethylene glycol and polypropylene glycol, and copolymer of polybutylene glycol and polyethylene glycol; fluorine-containing vinyl monomers, such as fluorine-substituted (meth)acrylic acid alkyl ester; acid anhydride group-containing monomers, such as maleic acid anhydride and itaconic acid anhydride; aromatic vinyl compound monomers, such as styrene, α-methylstyrene, and vinyl toluene; reactive halogen-containing vinyl monomers, such as 2-chloroethyl vinyl ether and monochloro vinyl acetate; amide group-containing vinyl monomers, such as (meth)acrylamide, N-isopropyl(meth)acrylamide, N-butyl(meth)acrylamide, N,N-diethyl(meth)acrylamide, N,N-dimethyl(meth)acrylamide, N-methylol(meth)acrylamide, N-ethylol(meth)acrylamide, N-methylolpropane(meth)acrylamide, N-methoxyethyl(meth)acrylamide, N-butoxymethyl(meth)acrylamide, and N-acryloyl morpholine; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexyl maleimide, N-isopropylmaleimide, N-lauryl maleimide, and N-phenyl maleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine, N-vinyl pyrazole, N-vinyl isoxazole, N-vinyl thiazole, N-vinyl isothiazole, and N-vinyl pyridazine; N-vinyl carboxylic acid amides; lactam monomers, such as N-vinyl caprolactam; cyano-containing monomers, such as (meth)acrylonitrile; (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl; imide group-containing monomers, such as cyclohexyl maleimide and isopropyl maleimide; isocyanate group-containing monomers, such as 2-isocyanate ethyl(meth)acrylate; organic silicon-containing vinyl monomers, such as vinyltrimethoxysilane, γ-methacryloxpropyl trimethoxy silane, allyltrimethoxysilane, trimethoxysilylpropylallylamine, and 2-methoxy ethoxy trimethoxy silane; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate; acrylic acid ester monomers having a heterocycle, halogen atom, silicon atom, or the like, such as (meth)acrylic acid tetrahydrofurfuryl, fluorine atom-containing (meth)acrylate, and silicone(meth)acrylate; olefin monomers, such as isoprene, butadiene, and isobutylene; vinyl ether monomers, such as methyl vinyl ether and ethyl vinyl ether; olefins or dienes, such as ethylene, butadiene, isoprene, and isobutylene; vinyl ethers, such as vinyl alkyl ether; vinyl chloride; and others, such as macro-monomers having a radically polymerizable vinyl group at the ends of monomers to which vinyl group are polymerized, etc. These monomers can be copolymerized, alone or in combination thereof, with the (meth)acrylic acid esters.

Examples of the (meth)acrylic polymer (B) include, for example, copolymer of cyclohexyl methacrylate (CHMA) and isobutyl methacrylate (IBMA), that of cyclohexyl methacrylate (CHMA) and isobornyl methacrylate (IBXMA), that of methyl methacrylate (MMA) and isobornyl methacrylate (IBXMA), that of cyclohexyl methacrylate (CHMA) and acryloyl morpholine (ACMO), that of cyclohexyl methacrylate (CHMA) and diethylacrylamide (DEAA), that of 1-adamantyl acrylate (ADA) and methyl methacrylate (MMA), that of dicyclopentanyl methacrylate (DCPMA) and isobornyl methacrylate (IBXMA), that of dicyclopentanyl methacrylate (DCPMA) and methyl methacrylate (MMA), that of dicyclopentanyl methacrylate (DCPMA) and N-vinyl-2-pyrrolidone (NVP), that of dicyclopentanyl methacrylate (DCPMA) and hydroxyethyl methacrylate (HEMA), that of dicyclopentanyl methacrylate (DCPMA) and acrylic acid (AA), homopolymer of dicyclopentanyl methacrylate (DCPMA), that of cyclohexyl methacrylate (CHMA), that of isobornylmethacrylate (IBXMA), that of isobornyl acrylate (IBXA), that of dicyclopentanyl acrylate (DCPA), that of 1-adamantyl methacrylate (ADMA), that of 1-adamantyl acrylate (ADA), and that of methyl methacrylate (MMA), etc.

A functional group reactive with an epoxy group or an isocyanate group may be further introduced into the (meth)acrylic polymer (B). Examples of such a functional group include a hydroxyl group, carboxyl group, amino group, amide group, and mercapto group. In producing the (meth)acrylic polymer (B), a monomer having such a functional group may be used (copolymerized).

When a copolymer, formed of both the (meth)acrylic monomer having an alicyclic structure and another (meth)acrylic acid ester monomer or a copolymerizable monomer, is used as the (meth)acrylic polymer (B), the content ratio of the (meth)acrylic monomer having an alicyclic structure is 5% by mass or more, preferably 10% by mass or more, more preferably 20% by mass or more, and still more preferably 30% by mass or more (normally less than 100% by mass, and preferably 90% by mass or less), based on the total mass of the whole monomers that form the (meth)acrylic polymer (B). By including the (meth)acrylic monomer having an alicyclic structure in an amount of 5% by mass or more, the adhesiveness at low-speed peeling can be improved without the transparency being decreased. Further, by including the (meth)acrylic monomer having an alicyclic structure, moderate phase separation is generated between the (meth)acrylic polymer (B) and the compound (D) having a polyoxyalkylene chain, and the mobility of the ionic compound (C), which is conveyed by the polyoxyalkylene chain, is improved by the (meth)acrylic polymer (B), thereby nallowing an antistatic property to be improved. If the content thereof is less than 5% by mass, the adhesiveness, in particular, that at low-speed peeling may be decreased.

The weight average molecular weight (MwB) of the (meth)acrylic polymer (B) is 1000≦MwB<30000, preferably 1500≦MwB<20000, and more preferably 2000≦MwB<10000. If MwB≧30000, the adhesiveness at low-speed peeling is decreased. If MwB<1000, the molecular weight becomes too small, thereby causing the pressure-sensitive adhesive force (high-speed peeling force, low-speed peeling force) of the pressure-sensitive adhesive sheet to be decreased.

The weight average molecular weights of the polymer (A) and the (meth)acrylic polymer (B) can be determined by polystyrene conversion using gel permeation chromatography (GPC). Specifically, the measurement of the weight average molecular weight is performed in accordance with the method and conditions described in the later-described Examples.

The glass transition temperature (Tg) of the (meth)acrylic polymer (B) is 20° C. to 300° C., preferably 50° C. to 280° C., more preferably 90° C. to 280° C., and still more preferably 110° C. to 250° C. If Tg<20° C., both the high-speed peeling force and the low-speed peeling force, in which the pressure-sensitive adhesive force at high-speed peeling is small and the adhesive force at low-speed peeling is sufficiently large to an extent in which a trouble, such as lifting and unintended separation, is not caused, may not be achieved. The glass transition temperatures of typical materials that can be used as the (meth)acrylic polymer (B) in the present embodiment are shown in Table 1. The glass transition temperatures shown there are nominal values described in documents or catalogs, etc., or values calculated based on the following Equation (1) (Fox Equation).

1/Tg=W1/Tg1+W2/Tg2++Wn/Tgn (1)

[wherein Tg represents the glass transition temperature (unit: K) of the (meth)acrylic polymer (B); Tgi (i=1, 2, . . . , n) represents the glass transition temperature (unit: K) when monomer i forms a homopolymer; and Wi (i=1, 2, . . . , n) represents a mass fraction of the monomer i in the whole monomer components.]The above Equation (1) is adopted when the (meth)acrylic polymer (B) is formed of n types of monomer components of monomer 1, monomer 2, . . . , monomer n.

TABLE 1

| COMPOSITION OF | | |
|---|---|---|
| (METH)ACRYLIC | Tg | |
| POLYMER (B) | (° C.) | REMARKS |
| DCPMA | 175 | VALUES DESCRIBED IN |
| | | DOCUMENTS, ETC. |
| DCPA | 120 | VALUES DESCRIBED IN |
| | | DOCUMENTS, ETC. |
| IBXMA | 173 | VALUES DESCRIBED IN |
| | | DOCUMENTS, ETC. |
| IBXA | 97 | VALUES DESCRIBED IN |
| | | DOCUMENTS, ETC. |
| CHMA | 66 | VALUES DESCRIBED IN |
| | | DOCUMENTS, ETC. |
| CHA | 15 | VALUES DESCRIBED IN |
| | | DOCUMENTS, ETC. |
| IBMA | 48 | VALUES DESCRIBED IN |
| | | DOCUMENTS, ETC. |
| MMA | 105 | VALUES DESCRIBED IN |
| | | DOCUMENTS, ETC. |
| ADMA | 250 | VALUES DESCRIBED IN |
| | | DOCUMENTS, ETC. |
| ADA | 153 | VALUES DESCRIBED IN |
| | | DOCUMENTS, ETC. |
| NVP | 54 | VALUES DESCRIBED IN |
| | | DOCUMENTS, ETC. |
| HEMA | 40 | VALUES DESCRIBED IN |
| | | DOCUMENTS, ETC. |
| DCPMA/MMA = 40/60 | 130 | CALCULATED VALUES |
| | | (BASED ON Fox EQUATION) |
| IBXA/MMA = 40/60 | 130 | CALCULATED VALUES |
| | | (BASED ON Fox EQUATION) |
| CHMA/IBMA = 60/40 | 59 | CALCULATED VALUES |
| | | (BASED ON Fox EQUATION) |
| DCPMA/NVP = 60/40 | 117 | CALCULATED VALUES |
| | | (BASED ON Fox EQUATION) |

The abbreviations in Table 1 represent the following compounds.

DCPMA: Dicyclopentanyl Methacrylate

DCPA: Dicyclopentanyl Acrylate

IBXMA: Isobornyl Methacrylate

IBXA: Isobornyl Acrylate

CHMA: Cyclohexyl Methacrylate

CHA: Cyclohexyl Acrylate

IBMA: Isobutyl Methacrylate

MMA: Methyl Methacrylate

ADMA: 1-Adamantyl Methacrylate

ADA: 1-Adamantyl Acrylate

NVP: N-Vinyl-2-Pyrrolidone

The (meth)acrylic polymer (B) can be produced, for example, by subjecting the (meth)acrylic monomer having the aforementioned structure to polymerization with the use of a solution polymerization method, bulk polymerization method, emulsion polymerization method, suspension polymerization, and block polymerization, etc.

In order to adjust the molecular weight of the (meth)acrylic polymer (B), a chain transfer agent can be used while the polymer (B) is being polymerized. Examples of the chain transfer agent to be used include: compounds having a mercapt group, such as octylmercaptan, laurylmercaptan, t-dodecyl mercaptan, mercaptoethanol, and α-thioglycerol; thioglycolic acid, methyl thioglycolate, ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, and thioglycolic acid esters including thioglycolic acid ester of ethylene glycol, thioglycolic acid ester of neopentyl glycol, and thioglycolic acid ester of pentaerythritol; and α-methylstyrene dimer, etc.

The use amount of the chain transfer agent is not particularly limited, but the chain transfer agent is usually included in an amount 0.1 parts by mass to 20 parts by mass, preferably 0.2 parts by mass to 15 parts by mass, and more preferably 0.3 parts by mass to 10 parts by mass, based on 100 parts by mass of the (meth)acrylic monomer. By adjusting the addition amount of the chain transfer agent, as stated above, the (meth)acrylic polymer (B) having a preferred molecular weight can be obtained. The chain transfer agents can be used alone or in combination of two or more thereof.

### [Ionic Compound (C)]

The ionic compound is a compound exhibiting an ionic dissociation property at normal temperature, and can be exemplified by an alkali metal salt and/or an ionic liquid, etc. Because the alkali metal salt has a high ionic dissociation property even when included in a very small amount, it can exhibit an excellent antistatic property while suppressing the contamination to an adherend, which makes the alkali metal salt to be useful. On the other hand, the ionic liquid exhibits excellent conductivity itself, and hence a sufficient antistatic property can be provided when the ionic liquid is included in the pressure-sensitive adhesive layer in a very small amount, which makes the ionic liquid to be useful. Because the ionic liquid is a liquid, it can be uniformly transferred to an adherend even when included in a very small amount, thereby allowing an excellent antistatic property to be exhibited while the contamination to an adherend is being suppressed.

The metal salts, formed, for example, of cations, such as Li⁺, Na⁺, and K⁺, and anions, such as Cl⁻, Br⁻, I⁻, BF₄⁻, PF₆⁻, SCN⁻, ClO₄⁻, CF₃SO₃⁻, (FSO₂)₂N⁻, (CF₃SO₂)₂N⁻, (C₂F₅SO₂)₂N⁻, and (CF₃SO₂)₃C⁻, can be preferably used as the alkali metal salts. Lithium salts, such as LiBr, LiI, LiBF₄, LiPF₆, LiSCN, LiClO₄, LiCF₃SO₃, Li(FSO₂)₂N, Li(CF₃SO₂)₂N, Li(C₂F₅SO₂)₂N, and Li(CF₃SO₂)₃Cᵣ can be used preferably, and among them, LiClO₄, LiCF₃SO₃, Li(CF₃SO₂)₂N, Li(C₂F₅SO₂)₂N, and Li(CF₃SO₂)₃C can be used more preferably. These alkali metal salts may be used alone or in combination of two or more thereof.

The ionic liquid refers to a molten salt presenting a liquid form at room temperature (25° C.). Because the ionic liquid is in a liquid form at room temperature, addition, dispersion, or dissolution into the pressure-sensitive adhesive composition can be performed more easily in comparison with a solid salt. Further, the ionic liquid has no vapor pressure (non-volatility), and hence it does not disappear over time, thereby allowing an antistatic property to be obtained continuously.

In the pressure-sensitive adhesive composition according to the present embodiment, it is desirable that the ionic liquid is one or more of a nitrogen-containing onium salt, sulfur-containing onium salt, and phosphorus-containing onium salt.

In the pressure-sensitive adhesive composition according to the present embodiment, it is desirable that the ionic liquid includes one or more cations represented by the following general formulae (C1) to (C4). By using the ionic liquid including these cations, a pressure-sensitive adhesive composition further excellent in an antistatic property can be obtained.

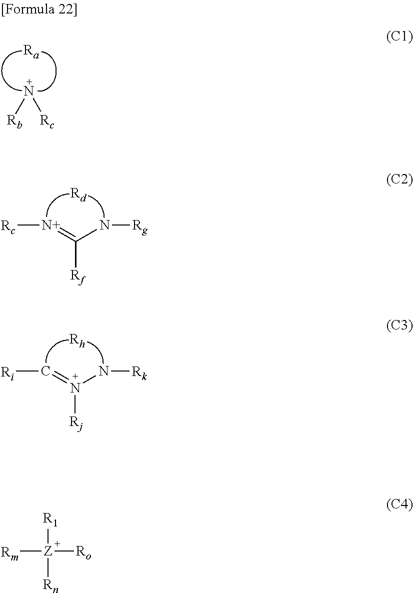

[In the formula (C1), Rₐ represents a C₄₋₂₀ hydrocarbon group and may include a hetero atom; each of R_{b} and Rₑ represents the same or different hydrogen or C₁₋₁₆ hydrocarbon group and may include a hetero atom. However, when the nitrogen atom includes a double bond, R_{c} is not present.]

[In the formula (C2), R_{d} represents a C₂₋₂₀ hydrocarbon group and may include a hetero atom; each of Rₑ, R_{f}, and R_{g} represents the same or different hydrogen or C₁₋₁₆ hydrocarbon group and may include a hetero atom.]

[In the formula (C3), Rₕ represents a C₂₋₂₀ hydrocarbon group and may include a hetero atom; each of Rᵢ, Rⱼ, and Rₖ represents the same or different hydrogen or C₁₋₁₆ hydrocarbon group and may include a hetero atom.]

[In the formula (C4), Z represents a nitrogen atom, a sulfur atom, or a phosphorus atom; each of Rₗ, Rₘ, Rₙ, and Rₒ represents the same or different C₁₋₂₀ hydrocarbon group and may include a hetero atom. However, when Z is a sulfur atom, Rₒ is not present.]

Examples of the cation represented by the formula (C1) include, for example, a pyridinium cation, piperidinium cation, pyrrolidinium cation, cation having a pyrroline skeleton, and cation having a pyrrole skeleton, etc.

Specific examples of the cation include, for example, 1-ethylpyridinium cation, 1-butylpyridinium cation, 1-hexylpyridinium cation, 1-butyl-3-methylpyridinium cation, 1-butyl-4-methylpyridinium cation, 1-hexyl-3-methylpyridinium cation, 1-butyl-3,4-dimethylpyridinium cation, 1,1-dimethylpyrrolidinium cation, 1-methyl-1-ethylpyrrolidinium cation, 1-methyl-1-propylpyrrolidinium cation, 1-methyl-1-butylpyrrolidinium cation, 1-methyl-1-pentylpyrrolidinium cation, 1-methyl-1-hexylpyrrolidinium cation, 1-methyl-1-heptylpyrrolidinium cation, 1-ethyl-1-propylpyrrolidinium cation, 1-ethyl-1-butylpyrrolidinium cation, 1-ethyl-1-pentylpyrrolidinium cation, 1-ethyl-1-hexylpyrrolidinium cation, 1-ethyl-1-heptylpyrrolidinium cation, 1,1-dipropylpyrrolidinium cation, 1-propyl-1-butylpyrrolidinium cation, 1,1-dibutylpyrrolidinium cation 1-propylpiperidinium cation, 1-pentylpiperidinium cation, 1,1-dimethylpiperidinium cation, 1-methyl-1-ethylpiperidinium cation, 1-methyl-1-propylpiperidinium cation, 1-methyl-1-butylpiperidinium cation, 1-methyl-1-pentylpiperidinium cation, 1-methyl-1-hexylpiperidinium cation, 1-methyl-1-heptylpiperidinium cation, 1-ethyl-1-propylpiperidinium cation, 1-ethyl-1-butylpiperidinium cation, 1-ethyl-1-pentylpiperidinium cation, 1-ethyl-1-hexylpiperidinium cation, 1-ethyl-1-heptylpiperidinium cation, 1,1-dipropylpiperidinium cation, 1-propyl-1-butylpiperidinium cation, 1-propyl-1-butylpiperidinium cation, 1-propyl-1-pentylpiperidinium cation, 1-propyl-1-hexylpiperidinium cation, 1-propyl-1-heptylpiperidinium cation, 1,1-dibutylpiperidinium cation, 1-butyl-1-pentylpiperidinium cation, 1-butyl-1-hexylpiperidinium cation, 1-butyl-1-heptylpiperidinium cation, 2-methyl-1-pyrroline cation, 1-ethyl-2-phenylindole cation, 1,2-dimethylindole cation, 1-ethylcarbazole cation, etc.

Examples of the cation represented by the formula (C2) include, for example, an imidazolium cation, tetrahydropyrimidinium cation, dihydropyrimidinium cation, etc.

Specific examples of the cation include, for example, 1,3-dimethylimidazolium cation, 1,3-diethylimidazolium cation, 1-ethyl-3-methylimidazolium cation, 1-butyl-3-methylimidazolium cation, 1-hexyl-3-methylimidazolium cation, 1-octyl-3-methylimidazolium cation, 1-decyl-3-methylimidazolium cation, 1-dodecyl-3-methylimidazolium cation, 1-tetradecyl-3-methylimidazolium cation, 1-hexadecyl-3-methylimidazolium cation, 1-octadecyl-3-methylimidazolium cation, 1,2-dimethyl-3-propylimidazolium cation, 1-ethyl-2,3-dimethylimidazolium cation, 1-butyl-2,3-dimethylimidazolium cation, 1-hexyl-2,3-dimethylimidazolium cation, 1,3-dimethyl-1,4,5,6-tetrahydropyrimidinium cation, 1,2,3-trimethyl-1,4,5,6-tetrahydropyrimidinium cation, 1,2,3,4-tetramethyl-1,4,5,6-tetrahydropyrimidinium cation, 1,2,3,5-tetramethyl-1,4,5,6-tetrahydropyrimidinium cation, 1,3-dimethyl-1,4-dihydropyrimidinium cation, 1,3-dimethyl-1,6-dihydropyrimidinium cation, 1,2,3-trimethyl-1,4-dihydropyrimidinium cation, 1,2,3-trimethyl-1,6-dihydropyrimidinium cation, 1,2,3,4-tetramethyl-1,4-dihydropyrimidinium cation, 1,2,3,4-tetramethyl-1,6-dihydropyrimidinium cation, etc.

Examples of the cation represented by the formula (C3) include, for example, a pyrazolium cation and pyrazolinium cation, etc.

Specific examples of the cation include, for example, 1-methylpyrazolium cation, 3-methylpyrazolium cation, 1-ethyl-2-methylpyrazolinium cation, 1-ethyl-2,3,5-trimethylpyrazolium cation, 1-propyl-2,3,5-trimethylpyrazolium cation, 1-butyl-2,3,5-trimethylpyrazolium cation, etc.

Examples of the cation represented by the formula (C4) include, for example, a tetraalkyl ammonium cation, trialkylsulfonium cation, tetraalkyl phosphonium cation, and a cation in which part of the above alkyl group is replaced by an alkenyl group, an alkoxyl group, or an epoxy group, etc.

Specific examples of the cation include, for example, tetramethylammonium cation, tetraethylammonium cation, tetrapropylammonium cation, tetrabutylammonium cation, tetrapentylammonium cation, tetrahexylammonium cation, tetraheptylammonium cation, triethylmethyammonium cation, tributylethylammonium cation, trimethyldecylammonium cation, trioctylmethylammonium cation, tripentylbutylammonium cation, trihexylmethylammonium cation, trihexylpentylammonium cation, triheptylmethylammonium cation, tripentylbutylammonium cation, triheptylhexylammonium cation, dimethyldihexylammonium cation, dipropyldihexylammonium cation, heptyldimethylhexylammonium cation, N,N-diethyl-N-methyl-N-(2-methoxyethyl)ammonium cation, glycidyltrimethylammonium cation, diallyldimethylammonium cation, N,N-dimethyl-N,N-dipropylammonium cation, N,N-dimethyl-N,N-dihexylammonium cation, N,N-dipropyl-N,N-dihexylammonium cation, N,N-dimethyl-N-ethyl-N-propylammonium cation, N,N-dimethyl-N-ethyl-N-butylammonium cation, N,N-dimethyl-N-ethyl-N-pentylammonium cation, N,N-dimethyl-N-ethyl-N-hexylammonium cation, N,N-dimethyl-N-ethyl-N-heptylammonium cation, N,N-dimethyl-N-ethyl-N-nonylammonium, N,N-dimethyl-N-propyl-N-butylammonium cation, N,N-dimethyl-N-propyl-N-pentylammonium cation, N,N-dimethyl-N-propyl-N-hexylammonium cation, N,N-dimethyl-N-propyl-N-heptylammonium cation, N,N-dimethyl-N-butyl-N-hexylammonium cation, N,N-dimethyl-N-butyl-N-heptylammonium cation, N,N-dimethyl-N-pentyl-N-hexylammonium cation, trimethylheptylammonium cation, N,N-diethyl-N-methyl-N-propylammonium cation, N,N-diethyl-N-methyl-N-pentylammonium cation, N,N-diethyl-N-methyl-N-heptylammonium cation, N,N-diethyl-N-propyl-N-pentylammonium cation, triethylmethylammonium cation, triethylpropylammonium cation, triethylpentylammonium cation, triethylheptylammonium cation, N,N-dipropyl-N-methyl-N-ethylammonium cation, N,N-dipropyl-N-methyl-N-pentylammonium cation, N,N-dipropyl-N-butyl-N-hexylammonium cation, N,N-dipropyl-N,N-dihexylammonium cation, N,N-dibutyl-N-methyl-N-pentylammonium cation, N,N-dibutyl-N-methyl-N-hexylammonium cation, N,N-dimethyl-N,N-dihexylammonium cation, trioctylmethylammonium cation, N-methyl-N-ethyl-N-propyl-N-pentylammonium cation, trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, tetrapentylphosphonium cation, tetrahexylphosphonium cation, phosphonium cation, tetraheptylphosphonium cation, tetraoctylphosphonium cation, triethylmethylphosphonium cation, tributylethylphosphonium cation, trimethyldecylphosphonium cation, etc.

Among them, tetraalkylammonium cations, such as tetramethylammonium cation, tetraethylammonium cation, tetrapropylammonium cation, tetrabutylammonium cation, tetrapentylammonium cation, tetrahexylammonium cation, tetraheptylammonium cation, triethylmethylammonium cation, tributylethylammonium cation, trimethyldecylammonium cation, trioctylmethylammonium cation, tripentylbutylammonium cation, trihexylmethylammonium cation, trihexylpentylammonium cation, triheptylmethylammonium cation, tripentylbutylammonium cation, triheptylhexylammonium cation, dimethyldihexylammonium cation, dipropyldihexylammonium cation, heptyldimethylhexylammonium cation, N,N-diethyl-N-methyl-N-(2-methoxyethyl)ammonium cation, glycidyltrimethylammonium cation, diaryldimethylammonium cation, N,N-dimethyl-N-ethyl-N-propylammonium cation, N,N-dimethyl-N-ethyl-N-butylammonium cation, N,N-dimethyl-N-ethyl-N-pentylammonium cation, N,N-dimethyl-N-ethyl-N-hexylammonium cation, N,N-dimethyl-N-ethyl-N-heptylammonium cation, N,N-dimethyl-N-ethyl-N-nonylammonium cation, N,N-dimethyl-N-propyl-N-butylammonium cation, N,N-dimethyl-N-propyl-N-pentylammonium cation, N,N-dimethyl-N-propyl-N-hexylammonium cation, N,N-dimethyl-N-propyl-N-heptylammonium cation, N,N-dimethyl-N-butyl-N-hexylammonium cation, N,N-dimethyl-N-butyl-N-heptylammonium cation, N,N-dimethyl-N-pentyl-N-hexylammonium cation, trimethylheptylammonium cation, N,N-diethyl-N-methyl-N-propylammonium cation, N,N-diethyl-N-methyl-N-pentylammonium cation, N,N-diethyl-N-methyl-N-heptylammonium cation, N,N-diethyl-N-propyl-N-pentylammonium cation, N,N-dimethyl-N,N-dihexylammonium cation, triethylmethylammonium cation, triethylpropylammonium cation, triethylpentylammonium cation, triethylheptylammonium cation, N,N-dipropyl-N-methyl-N-ethylammonium cation, N,N-dipropyl-N-methyl-N-pentylammonium cation, N,N-dipropyl-N-butyl-N-hexylammonium cation, N,N-dipropyl-N,N-dihexylammonium cation, N,N-dibutyl-N-methyl-N-pentylammonium cation, N,N-dibutyl-N-methyl-N-hexylammonium cation, trioctylmethylammonium cation, and N-methyl-N-ethyl-N-propyl-N-pentylammonium cation; trialkylsulfonium cations, such as trimethylsulfonium cation, triethylsulfonium cation, tributylsulfonium cation, trihexylsulfonium cation, diethylmethylsulfonium cation, dibutylethylsulfonium cation, and dimethyldecylsulfonium cation; and tetraalkylphosphonium cations, such as tetramethylphosphonium cation, tetraethylphosphonium cation, tetrabutylphosphonium cation, tetrapentylphosphonium cation, tetrahexylphosphonium cation, tetraheptylphosphonium cation, tetraoctylphosphonium cation, triethylmethylphosphonium cation, tributylethylphosphonium cation, tributylethylphosphonium cation, and trimethyldecylphosphonium cation, etc., can be preferably used.

On the other hand, the anion components are not particularly limited, as far as they meet a requirement to become a liquid. For, example, Cl⁻, Br⁻, I⁻, SCN⁻, AkCl₄⁻, Al₂Cl₇⁻, BF₄⁻. PF₆⁻, ClO₄⁻, NO₃, CH₃COO⁻, CF₃COO⁻, CH₃SO₃⁻, CF₃SO₃⁻, (FSO₂)₂N⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, B (CN)₄⁻, C(CN)₃⁻, N(CN)₂⁻, CH₃OSO₃⁻, C₂H₅OSO₃⁻, C₄H₉OSO₃⁻, C₆H₁₃OSO₃⁻, C₈H₁₂OSO₃⁻, p-toluenesulfonate anion, 2-(2-methoxyethyl)ethylsulfate anion, and (C₂F₅)₃PF₃⁻, etc., can be used. Among them, the anion components including a fluorine atom can obtain ion liquids that have a low melting point and that are excellent in the compatibility with acrylic polymers, and hence they are preferably used. Also, anion components represented by the following formula can be used.

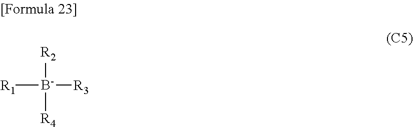

[wherein each of R1 to R4 independently represents a hydrogen atom, an alkyl group that may have a substituent group, an alkenyl group that may have a substituent group, an alkynyl group that may have a substituent group, an aryl group that may have a substituent group, or a heterocycle group that may a substituent group. The hydrogen atom in the substituent groups may further be replaced by another substituent group (electron-attracting substituent groups, etc.).]

Among the ionic compounds to be used in the present embodiment, specific examples of the ionic liquids can be appropriately selected from the combinations of the aforementioned cation components and the anion components. For example, 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(fluorosulfonyl)imide, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-3-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1,1-diethylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1-propyl-1-pentylpyrrolidinium bis(trifluoromethanesulfonyl)imide, 1-propyl-1-hexylpyrrolidinium bis(trifluoromethanesulfonyl)imide, 1-propyl-1-heptylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dibutylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1,1-diethylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1-propyl-1-pentylpiperidinium bis(trifluoromethanesulfonyl)imide, 1-propyl-1-hexylpiperidinium bis(trifluoromethanesulfonyl)imide, 1-propyl-1-heptylpiperidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dibutylpiperidinium bis(trifluoromethanesulfonyl)imide, 1-propylpyrrolidinium bis(pentafluoroethanesulfonyl)imide, 1-pentylpyrrolidinium bis(pentafluoroethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1,1-diethylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1-propyl-1-pentylpyrrolidinium bis(pentafluoroethanesulfonyl)imide, 1-propyl-1-hexylpyrrolidinium bis(pentafluoroethanesulfonyl)imide, 1-propyl-1-heptylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1,1-diethylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1-propyl-1-pentylpiperidinium bis(pentafluoroethanesulfonyl)imide, 1-propyl-1-hexylpiperidinium bis(pentafluoroethanesulfonyl)imide, 1-propyl-1-heptylpiperidinium bis(pentafluoroethanesulfonyl)imide, 1,1-dibutylpiperidinium bis(pentafluoroethanesulfonyl)imide, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-3-methylimidazolium hexafluorophosphate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazolium bis(fluorosulfonyl)imide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(fluorosulfonyl)imide, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, 1-hexyl-3-methylimidazolium bis(fluorosulfonyl)imide, 1-octyl-3-methylimidazolium tetrafluoroborate, 1-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-methylpyrazolium tetrafluoroborate, 3-methylpyrazolium tetrafluoroborate, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium(trifluoromethanesulfonyl)trifluoroacetamide, 1-butyl-3-methylpyridinium(trifluoromethanesulfonyl)trifluoro acetamide, 1-ethyl-3-methylimidazolium(trifluoromethanesulfonyl)trifluoroacetamide, tetrahexylammonium bis(trifluoromethanesulfonyl)imide, N,N-diethyl-N-methyl-N-(2-methoxyethyl)ammonium tetrafluoroborate, N,N-diethyl-N-methyl-N-(2-methoxyethyl)ammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, diallyldimethylammonium (trifluoromethanesulfonyl)trifluoroacetamide, glycidyltrimethylammonium(trifluoromethanesulfonyl)trifluoroacetamide, diallyldimethylammonium bis(pentafluoroethanesulfonyl)imide, diallyldimethyl bis(pentafluoroethanesulfonyl)imide, 1-octyl-3-methylimidazolium chloride, 1-decyl-3-methylimidazolium chloride, 1-dodecyl-3-methylimidazolium chloride, 1-tetradodecyl-3-methylimidazolium chloride, 1-hexadodecyl-3-methylimidazolium chloride, 1-hexyl-2,3-dimethylimidazolium bromide, 1-hexyl-2,3-dimethylimidazolium chloride, 1-butylpyridinium trifluoromethanesulfonate, 1-hexylpyridinium bromide, and 1-hexylpyridinium chloride, etc., can be used.

Among them, the cyclic nitrogen-containing onium cation components represented by the formulae (C1) to (C3) are preferably used. By using these cyclic nitrogen-containing onium cation components, the peeling-charged electrostatic potential to be provided to an adherend can be further effectively reduced, even when the contents of the above onium cation components are small. The cyclic cations may be ones: that are aromatic; the unsaturated bond of which is saturated, or that have a degree of saturation.

Such an ionic liquid may be commercially available, but can be synthesized in the following way.

A method of synthesizing the ionic liquid is not particularly limited, as far as a target ionic liquid can be obtained; however, a halide method, hydroxide method, acid ester method, complex-forming method, and neutralization method, etc., which are described in the document: “The Front and Future of Material Development-Ionic Liquid” (CMC Publishing Co., Ltd.)” are generally adopted.

With respect to the halide method, hydroxide method, acid ester method, complexing method, and neutralization method, method of synthesizing a nitrogen-containing onium salt, which is taken as an example, will be described below; however, other ionic liquids, such as a sulfur-containing onium salt and phosphorus-containing onium salt, can be obtained by the same methods.

The halide method is performed according to the reactions as indicated by the following formulae (I) to (3). A halide is first obtained by a reaction between a tertiary amine and an alkyl halide (formula (1), chlorine, bromine, or iodine is used as the halogen).

A target ionic liquid (R₄NA) can be obtained by making the obtained halide react with an acid (HA) having an anion structure (A⁻) of the target ionic liquid or with a salt (MA, wherein M is a cation that forms a salt along with a target anion, such as ammonium, lithium, sodium, or potassium).

[Formula 24]

R₃N+RX→R₄NX (X: Cl, Br, I) (1)

R₄NX+HA→R₄NA+HX (2)

RₙNX+MA→R₄NA+MX (M: NH₄, Li, Na, K, Ag, etc.) (3)

The hydroxide method is performed according to the reactions as indicated by the following formulae (4) to (8). A hydroxide (R₄NOH) is first obtained by subjecting a halide (R₄NX) to an ion exchange membrane process electrolysis (reaction formula (4)) or to an OH-type ion-exchange resin method (reaction formula (5)), or making the halide (R₄NX) react with silver oxide (Ag₂O) (reaction formula (6)) (herein, chlorine, bromine, or iodine is used as the halogen).

The target ionic liquid (R₄NA) can be obtained by subjecting the obtained hydroxide to the reactions indicated by the reaction formulae (7) and (8), similarly to the aforementioned halide method.

[Formula 25]

R₄NX+H₂O→R₄NOH+½H₂+½X₂ (X: Cl, Br, I) (4)

R₄NX+P—OH→R₄NOH+P—X (P—OH: OH-TYPE ION EXCHANGE RESIN) (5)

R₄NX+½Ag₂O+½H₂O→R₄NOH+AgX (6)

R₄NOH+MA→R₄NA+H₂O (7)

R₄NOH+MA→R₄NA+MON (M: NH₄, Li, Na, K, Ag, etc.) (8)

The acid ester method is performed according to the reactions as indicated by the formulae (9) to (11). An acid ester substance is first obtained by making a tertiary amine (R₃N) react with an acid ester (reaction formula (9), wherein an ester of an inorganic acid, such as sulfuric acid, sulfurous acid, phosphoric acid, phosphorous acid, or carbonic acid, or an ester of an organic acid, such as methanesulfonic acid, methylphosphonic acid, or formic acid, is used as the acid ester).

The target ionic liquid (R₄NA) can be obtained by subjecting the obtained acid ester substance to the reactions indicated by the reaction formulae (10) and (11), similarly to the aforementioned halide method. Alternatively, the ionic liquid can be directly obtained by using methyl trifluoromethane sulfonate, methyl trifluoro acetate, or the like, as the acid ester.

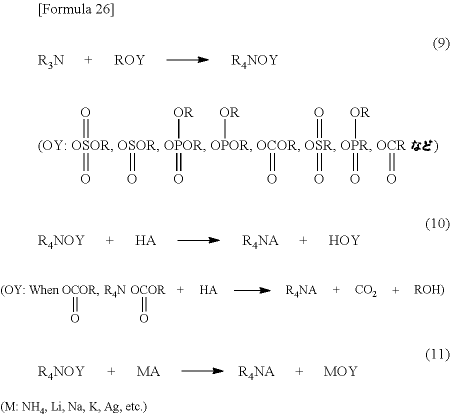

The complexing method is performed according to the reactions as indicated by the formulae (12) to (15). A quaternary ammonium fluoride salt is first obtained by making a halide of quaternary ammonium (R₄NX), hydroxide of quaternary ammonium (R₄NOH), carbonate ester compound of quaternary ammonium (R₄NOCO₂CH₃), or the like, react with hydrogen fluoride (HF) or ammonium fluoride (NH₄F) (reaction formulae (12) to (14)).

The ionic liquid can be obtained by a complex forming reaction between the obtained quaternary ammonium fluoride salt and a fluoride, such as BF₃, AlF₃, PF₅, ASF₅, SbF₅, NbF₅, TaF₅, or the like (Reaction formula (15)).

[Formula 27]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

(15) R₄NF+MFₙ₋₁→R₄NMFₙ (15)
(MFₙ₋₁: BF₃, AlF₃, PF₅, ASF_{E}, SbF_{B}, NbF₅, TaF₆, etc.)

The neutralization method is performed according to the reaction as indicated by the formula (16). The ionic liquid can be obtained by a reaction between a tertiary amine and an organic acid, such as HBF₄, HPF₆, CH₃COOH, CF₃COOH, CF₃SO₃H, (CF₃SO₂)₂NH, (CF₃SO₂)₃CH, (C₂F₅SO₂)₂NH, or the like.

[Formula 28]

R₃N+HZ→R₃HN⁺Z⁻ (16)
[HZ: HBF₄, HPF₆, AND ORGANIC ACIDS, SUCH AS CH₃COOH, CF₃COOH, CF₃SO₃H, (CF₃SO₂)₂NH, (CF₃SO₂)₃CH, (C₂F₅SO₂)₂NH]

R described in each of (1) to (16) represents hydrogen or a C₁₋₂₀ hydrocarbon group and may include a hetero atom.

### [Compound (D) Having Polyoxyalkylene Chain]

The compound (D) having a polyoxyalkylene chain is not particularly limited, as far as it is a compound having a polyoxyalkylene chain. Examples of the oxyalkylene unit include ones having a C₁₋₆ alkylene group, and specifically include, for example, an oxymethylene group, oxyethylene group, oxypropylene group, and oxybutylene group, etc. The hydrocarbon group of the oxyalkylene chain may be linear or branched. Examples of the compound (D) include, for example, polyethylene glycol, polypropylene glycol (diol type), polypropylene glycol (triol type), polytetramethylene ether glycol, methoxy polyethylene glycol, ethoxy polyethylene glycol, and derivatives and copolymers thereof. These compounds may be used alone or in combination of two or more thereof. When interacting with an ionic compound, the polyoxyalkylene chain conveys an ion by the molecular movement of the chain, while promoting the dissociation of ions, and hence it provides an effect of enhancing ion conductivity.

The number average molecular weight of the compound having a polyoxyalkylene chain is 100,000 or less, and preferably 200 to 50,000. If the number average molecular weight is 100,000 or more, the contamination to an adherend is increased.

The compound (D) having a polyoxyalkylene chain may be organopolysiloxane having a polyoxyalkylene chain represented by each of the following general formulae (D1) to (D3).

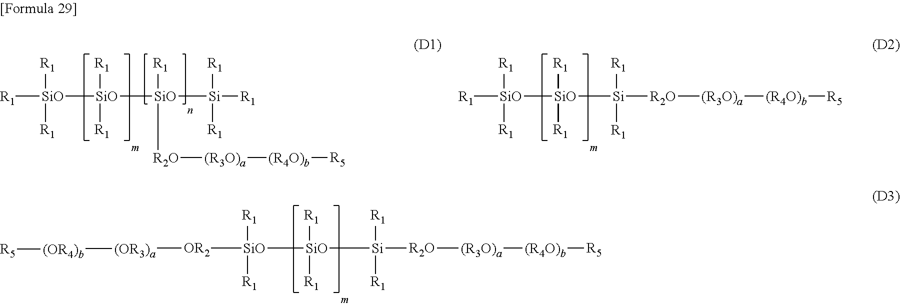

[In the formula (D1), R₁ is a monovalent organic group; each of R₂, R₃, and R₄ is an alkylene group; R₅ is a hydroxyl group or an organic group; each of m and n is an integer of 0 to 1000, however, m and n are not 0 at a time; and each of a and b is an integer of 0 to 1000, however, a and b are not 0 at a time.]

[In the formula (D2), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

[In the formula (D3), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

The organopolysiloxane having a polyoxyalkylene chain in the present embodiment may have a structure described below. Specifically, R₁ in the formulae is a monovalent organic group exemplified by: an alkyl group, such as a methyl group, ethyl group, propyl group, or the like; an aryl group, such as a phenyl group, tolyl group, or the like; or an aromatic alkyl group, such as a benzyl group, phenethyl group, or the like. Each of these groups may have a substituent group, such as a hydroxyl group. Each of R₂, R₃, and R₄ may be a C₁₋₈ alkylene group, such as a methylene group, ethylene group, propylene group, or the like. Herein, R₃ and R₄ are alkylene groups different from each other, and R₂ may or may not be the same as R₃ or R₄. It is preferable that one of R₃ and R₄ is an ethylene group or a propylene group in order to increase the concentration of an ionic compound that can be dissolved in the polyoxyalkylene side chain. R5 may be a monovalent organic group exemplified by: an alkyl group, such as a methyl group, ethyl group, propyl group, or the like; or an acyl group, such as an acetyl group, propionyl group, or the like. Each of the groups may have a substituent group, such as a hydroxyl group. These compounds may be used alone or in combination of two or more thereof. In addition, these compounds may have, in their molecules, a reactive substituent group, such as a (meth)acryl group, allyl group, hydroxyl group, or the like.

Specific examples of commercially-available organopolysiloxane having a polyoxyalkylene chain include, for example: product names of KF-351A, KF-353, KF-945, KF-6011, KF-889, and KF-6004 (these are made Shin-Etsu Chemical Co., Ltd.); product names of FZ-2122, FZ-2164, FZ-7001, SH8400, SH8700, SF8410, and SF8422 (these are made by Dow Corning Toray Co., Ltd.); product names of TSF-4440, TSF-4445, TSF-4452, and TSF-4460 (these are made by Momentive Performance Materials Inc.); product names of BYK-333, BYK-377, BYK-UV3500, and BYK-UV3570 (these are made by BYK Japan KK), etc. These compounds may be used alone or in combination of two or more thereof.

### [Pressure-Sensitive Adhesive Composition]

The pressure-sensitive adhesive composition according to the present embodiment comprises, as essential components, the aforementioned polymer (A), the (meth)acrylic polymer (B), the ionic compound (C), and the compound (D) having a polyoxyalkylene chain. The content of the (meth)acrylic polymer (B) is 0.05 parts by mass to 3 parts by mass, preferably 0.08 parts by mass to 2.5 parts by mass, and more preferably 0.1 parts by mass to 2 parts by mass, based on 100 parts by mass of the polymer (A). If the (meth)acrylic polymer (B) is added in an amount more than 3 parts by mass, the transparency of the pressure-sensitive adhesive layer formed by the acrylic pressure-sensitive adhesive composition according to the present embodiment is deteriorated. If the (meth)acrylic polymer (B) is added in an amount less than 0.05 parts by mass, both the high-speed peeling force and the low-speed peeling force, in which the pressure-sensitive adhesive force at high-speed peeling is small and the adhesive force at low-speed peeling is sufficiently large to an extent in which a trouble, such as lifting and unintended separation, is not caused, cannot be achieved. The content of the ionic compound (C) is 0.005 parts by mass to 1 part by mass, preferably 0.02 parts by mass to 0.8 parts by mass, and more preferably 0.025 parts by mass to 0.6 parts by mass, based on 100 parts by mass of the polymer (A). If the ionic compound (C) is added in an amount more than 1 part by mass, the cohesive force of the pressure-sensitive adhesive layer formed by the acrylic pressure-sensitive adhesive composition according to the present embodiment is decreased, and hence there is the tendency that the determination to an adherend is increased. If the ionic compound (C) is added in an amount less than 0.005 parts by mass, it becomes difficult to suppress the occurrence of a peeling-charged electrostatic potential. The content of the compound (D) having a polyoxyalkylene chain is 0.01 parts by mass to 2.5 parts by mass, preferably 0.05 parts by mass to 1.5 parts by mass, and more preferably 0.05 parts by mass to 1.5 parts by mass, based on 100 parts by mass of the polymer (A). If the compound having a polyoxyalkylene chain is added in an amount more than 2.5 parts by mass, the pressure-sensitive adhesive force of the pressure-sensitive adhesive layer formed by the peelable acrylic pressure-sensitive adhesive composition according to the present embodiment is decreased. If the compound having a polyoxyalkylene chain is added in an amount less than 0.01 parts by mass, it becomes difficult to suppress the occurrence of a peeling-charged electrostatic potential.

The pressure-sensitive adhesive composition according to the present embodiment may comprise, as arbitrary components, various additives that are common in the field of pressure-sensitive adhesive compositions, other than the aforementioned polymer (A), (meth)acrylic polymer (B), ionic compound (C), and compound (D) having a polyoxyalkylene chain. Such arbitrary components can be exemplified by a tackifying resin, cross-linking agent, catalyst, plasticizer, softener, filler, colorant (pigment, dye, or the like), antioxidant, leveling agent, stabilizer, antiseptic, and antistatic agent, etc. As such additives, conventionally- and publicly-known additives can be used by ordinary methods.

In order to adjust the cohesive force of the later-described pressure-sensitive adhesive layer, a cross-linking agent can also be used, other than the aforementioned polyfunctional monomer. Commonly-used cross-linking agents can be used as the cross-linking agent. Examples of the cross-linking agents include, for example: an epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. In particular, an isocyanate cross-linking agent, epoxy cross-linking agent, and metal chelate cross-linking agent can be preferably used. These compounds may be used alone or in combination of two or more thereof.

Specific examples of the isocyanate cross-linking agent include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane. Alternatively, a compound having, in one molecule, at least one isocyanate group and one or more unsaturated bonds, specifically 2-isocyanate ethyl(meth)acrylate, etc., can also be used as the isocyanate cross-linking agent. These compounds may be used alone or in combination of two or more thereof.

Examples of the epoxy cross-linking agent include: bisphenol A, epichlorohydrin type epoxy resin, ethyleneglycidylether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidyl amine, N,N,N′,N′-tetraglycidyl-m-xylylenediamine, and 1,3-bis(N,N-diglycidyl aminomethyl)cyclohexane, etc. These compounds may be used alone or in combination of two or more thereof.

Examples of the metal chelate compound include: as metal components, aluminum, iron, tin, titanium, and nickel; and as chelate components, acetylene, methyl acetoacetate, and ethyl lactate, etc. These compounds may be used alone or in combination of two or more thereof.

The cross-linking agent to be used in the present embodiment is included preferably in an amount of 0.01 parts by mass to 15 parts by mass, and more preferably in an amount of 0.5 parts by mass to 10 parts by mass, based on 100 parts by mass of the polymer (A). If the content of the cross-linking agent is less than 0.01 parts by mass, the cohesive force of the pressure-sensitive adhesive becomes small, and hence the contamination to an adherend may be caused. On the other hand, if the content of the cross-linking agent is more than 15 parts by mass, the cohesive force of the polymer becomes large and the flowability thereof is decreased, and hence the wetting may become insufficient and the adhesiveness be decreased.

The pressure-sensitive adhesive composition disclosed herein may further comprise a cross-linking catalyst for effectively promoting one of the aforementioned cross-linking reactions. As such a cross-linking catalyst, for example, a tin catalyst (in particular, dibutyl tin dilaurate) can be preferably used. The use amount of the cross-linking catalyst (e.g., a tin catalyst, such as dioctyl tin dilaurate) is not particularly limited, and it may be, for example, approximately 0.0001 parts by mass to 1 part by mass based on 100 parts by mass of the polymer (A).

The pressure-sensitive adhesive composition disclosed herein may comprises a compound that exhibits keto-enol tautomerism. For example, in the pressure-sensitive adhesive composition that comprises a cross-linking agent or that can be used by blending a cross-linking agent, an aspect in which the aforementioned compound exhibiting keto-enol tautomerism is included can be preferably adopted. Thereby, an effect of extending the pot life of the pressure-sensitive adhesive composition, after the cross-linking agent is blended, can be achieved by suppressing an excessive increase in the viscosity of the composition or the gelatinization thereof. When at least an isocyanate compound is used as the cross-linking agent, it is particularly significant to include a compound exhibiting keto-enol tautomerism. This technique can be preferably adopted, for example, when the pressure-sensitive adhesive composition is in a form of an organic solvent solution or in a non-solvent form.

Various β-dicarbonyl compounds can be used as the compound exhibiting keto-enol tautomerism. Specific examples of the compounds exhibiting keto-enol tautomerism include: β-diketones, such as acetylacetone, 2,4-hexanedione, 3,5-heptanedione, 2-methylhexane-3,5-dione, 6-methylheptane-2,4-dione, and 2,6-dimethylheptane-3,5-dione; acetoacetic esters, such as methyl acetoacetate, ethyl acetoacetate, isopropyl acetoacetate, and tert-butyl acetoacetate; propionyl acetate esters, such as ethyl propionyl acetate, isopropyl propionyl acetate, and tert-butyl, propionylacetate; isobutyryl acetate esters, such as, ethyl isobutyryl acetate, isopropyl isobutyryl acetate, and tert-butyl isobutyryl acetate; malonic esters, such as methyl malonate and ethyl malonate, etc. Among them, acetylacetone and acetoacetic esters can be preferably used. Such compounds exhibiting keto-enol tautomerism may be used alone or in combination of two or more thereof.

The use amount of the compound exhibiting keto-enol tautomerism may be, for example, 0.1 parts by mass to 20 parts by mass, and normally 0.5 parts by mass to 15 parts by mass (e.g., 1 part by mass to 10 parts by mass), based on 100 parts by mass the polymer (A). If the amount of the above compound is too small, a sufficient effect of using the compound may not be exhibited. On the other hand, if the compound is used in an amount larger than required, the compound may remain in the pressure-sensitive adhesive layer and the cohesive force may be decreased.

### [Pressure-Sensitive Adhesive Layer and Pressure-Sensitive Adhesive Sheet]

Subsequently, the structure of a pressure-sensitive adhesive sheet, having the pressure-sensitive adhesive layer that includes the pressure-sensitive adhesive composition having the aforementioned composition, will be described.

The pressure-sensitive adhesive layer according to the present embodiment can be a layer in which the pressure-sensitive adhesive composition has been cured. That is, the pressure-sensitive adhesive layer can be formed by providing the acrylic pressure-sensitive adhesive composition to an appropriate supporting body (e.g., coating) and then by appropriately subjecting to a curing treatment. When the supporting body is a plastics substrate that has been subjected to an antistatic treatment, the pressure-sensitive adhesive layer can also be formed on the antistatic layer, or can be formed on a surface that has not been subjected to the treatment. When two or more types of curing treatments (drying, cross-link formation, polymerization, etc.) are performed, these treatments can be performed simultaneously or in multiple stages. In the case of the pressure-sensitive adhesive composition in which a partial polymer (acrylic polymer syrup) has been used, a final copolymerization reaction is typically performed as the curing treatment (the partial polymer is subjected to a further copolymerization reaction to form a complete polymer). For example, in the case of a photo-curing pressure-sensitive adhesive composition, light radiation is performed. A curing treatment, such as cross-link formation, drying, or the like, may be performed, if necessary. For example, when the photo-curing pressure-sensitive adhesive composition needs to be dried, photo curing may be performed after the composition is dried. In the case of the pressure-sensitive adhesive composition in which a complete polymer has been used, a treatment, such as drying (drying by heating), cross-link formation, or the like, is typically performed as the curing treatment, if necessary.

The coating of the pressure-sensitive adhesive composition can be performed by using a commonly-used coater, such as, for example, a gravure roll coater, reverse roll coater, kiss roll coater, dip roll coater, bar coater, knife coater, spray coater, or the like. Alternatively, the pressure-sensitive adhesive layer may be formed by directly providing the pressure-sensitive adhesive composition to the supporting body, or the pressure-sensitive adhesive layer formed on a release liner may be transferred to the substrate.

In the present embodiment, it is desirable that the ratio of the solvent-insoluble component in the pressure-sensitive adhesive layer is 85.00% by mass to 99.95% by mass, and preferably 90.00% by mass to 99.95% by mass. If the ratio of the solvent-insoluble component is less than 85.00% by mass, the cohesive force becomes insufficient and an adherend (object to be protected) may be contaminated when peeled from the pressure-sensitive adhesive layer. If the ratio of the solvent-insoluble component is more than 99.95% by mass, the cohesive force becomes too large and sufficient pressure-sensitive adhesive force (high-speed peeling force, low-speed peeling force) may not be exhibited. A method of evaluating the ratio of the solvent-insoluble component will be described later.

The thickness of the pressure-sensitive adhesive layer is not particularly limited, but is normally 3 μm to 60 μm, and preferably 5 μm to 40 μm. By setting the thickness to be such ranges, sufficient adhesiveness can be achieved. If the thickness of the pressure-sensitive adhesive layer is less than 3 μm, the adhesiveness becomes insufficient and lifting and unintended separation may be caused. On the other hand, if the thickness thereof is more than 60 μm, the high-speed peeling force is increased and the peeling workability may be decreased.

The pressure-sensitive adhesive sheet according to the present embodiment comprises a pressure-sensitive adhesive layer made of the pressure-sensitive adhesive composition. In the pressure-sensitive adhesive sheet, such a pressure-sensitive adhesive layer is provided on at least one surface of the supporting body in a fixed manner, i.e., without an intention of separating the pressure-sensitive adhesive layer from the supporting body. The concept of the pressure-sensitive adhesive sheet described herein can involve objects referred to as a pressure-sensitive adhesive tape, a pressure-sensitive adhesive film, and a pressure-sensitive adhesive label, etc. The pressure-sensitive adhesive sheet may be one that is cut or punched so as to have an appropriate shape in accordance with its purpose of use. The pressure-sensitive adhesive layer should not be limited to one continuously formed, but may be one formed into a regular pattern, such as, for example, a dot shape and a stripe shape, or formed into a random pattern.

The aforementioned supporting body can be formed of a material appropriately selected, in accordance with the application of the pressure-sensitive adhesive tape, from the group consisting of, for example: plastic films, such as polyolefin films made of polyethylene, polypropylene, poly-1-butene, poly-4-methyl-1-pentene, ethylene propylene copolymer, ethylene 1-butene copolymer, ethylene vinyl acetate copolymer, ethylene ethyl acrylate copolymer, and ethylene vinyl alcohol copolymer, polyester films made of polyethylene terephthalate, polyethylenenaphthalate, and polybutylene terephthalate, polyacrylate film, polystyrene film, polyamide films made of nylon 6, nylon 6, 6, and partially aromatic polyamide, polyvinylchloride film, polyvinylidene chloride film, and polycarbonate film; foam substrates, such as a polyurethane foam, and polyethylene foam; paper, such as craft paper, crepe paper, and Japanese paper; cloth, such as cotton cloth and staple fiber cloth; nonwoven cloth, such as polyester nonwoven fabric and vinylon nonwoven fabric; metallic foils, such as aluminum foil and copper foil; and the like. When the peelable acrylic pressure-sensitive adhesive sheet according to the present embodiment is used as the later-described surface protective sheet, it is desirable to use plastic films, such as a polyolefin film, polyester film, and polyvinylchloride film, as the supporting body. In particular, when the acrylic pressure-sensitive adhesive sheet is used as an optical surface protective sheet, it is desirable to use a polyolefin film, polyethylene terephthalate film, polybutylene terephthalate film, and polyethylene naphthalate film. As the aforementioned plastic films, both of a non-oriented film and an oriented (uniaxially oriented or biaxially oriented) film can be used.

The supporting body can also be subjected to, if necessary: mold-release and antifouling treatments using a release agent, such as a silicone release agent, fluorine release agent, long-chain alkyl release agent, or fatty acid amide release agent, and a silica powder; and an easy-adhesion treatment, such as an acid treatment, alkali treatment, primer treatment, corona treatment, plasma treatment, ultraviolet treatment, or the like. The thickness of the supporting body can be appropriately selected in accordance with its purpose, but is generally within a range of approximately 5 μm to 200 μm (typically within a range of 10 μm to 100 μm).

The supporting body can also be subjected to, if necessary: mold-release and antifouling treatments using a release agent, such as a silicone release agent, fluorine release agent, long-chain alkyl release agent, or fatty acid amide release agent, and a silica powder; an easy-adhesion treatment, such as an acid treatment, alkali treatment, primer treatment, corona treatment, plasma treatment, ultraviolet treatment, or the like; and an antistatic treatment, such as a coating type, kneading type, vapor deposition type, or the like.

It is more desirable to use a plastic film that has been subjected to an antistatic treatment in the pressure-sensitive adhesive sheet according to the present embodiment. Because occurrence of static electricity can be prevented by an antistatic treatment, the pressure-sensitive adhesive sheet is useful in the technical field related to optical and electronic components in which electrostatic charge is particularly a serious problem. The antistatic treatment to be performed on a plastic film is not particularly limited, but a method of providing an antistatic layer on at least one surface of a film to be generally used and a method of kneading a kneading-type antistatic agent into a plastic film are adopted. Examples of the method of providing an antistatic layer on at least one surface of a film include: a method of coating an antistatic resin made of an antistatic agent and a resin component, a conductive polymer, or a conductive resin including a conductive substance; and a method of vapor-depositing or plating a conductive substance.

Examples of the antistatic treatment contained in an antistatic resin include: cationic antistatic agents having a cationic functional group, such as a quarternary ammonium salt, pyridinium salt, and primary, secondary, and tertiary amino groups; anionic antistatic agents having an anionic functional group, such as sulfonate, sulfuric ester salt, phosphonate, and phosphoric ester salt; amphoteric antistatic agents, such as alkylbetaine and its derivatives, imidazoline and its derivatives, and alanine and its derivatives; nonionic antistatic agents, such as aminoalcohol and its derivatives, glycerin and its derivatives, and polyethylene glycol and its derivatives; and ion conductive polymers obtained by polymerizing or copolymerizing a monomer having an ion-conductive group that is cationic, anionic, or amphoteric. These compounds may be used alone or in combination of two or more thereof.

Examples of the cationic antistatic agent include: (meth)acrylate copolymers having a quaternary ammonium group, such as an alkyltrimethyl ammonium salt, acyloxy amide propyl trimethyl ammonium methosulfate, alkyl benzyl dimethyl ammonium salt, acylcholine chloride, and polydimethyl aminoethyl methacrylate; styrene copolymers having a quaternary ammonium group, such as polyvinylbenzyltrimethyl ammonium chloride; and diarylamine copolymers having a quaternary ammonium, such as polydiallyldimethyl ammonium chloride, etc. These compounds may be used alone or in combination of two or more thereof.

Examples of the anionic antistatic agent include, for example, an alkylsulfonic acid salt, alkylbenzenesulfonic acid salt, alkylsulfuric ester salt, alkylethoxysulfuric ester salt, alkylphosphoric acid ester salt, and sulfonic group-containing styrene copolymer. These compounds may be used alone or in combination of two or more thereof.

The examples of the amphoteric antistatic agent include, for example, an alkyl betaine, alkyl imidazolium betaine, and carbobetaine graft copolymer. These compounds may be used alone or in combination of two or more thereof.

Examples of the nonionic antistatic agent include, for example, a fatty acid alkylol amide, di(2-hydroxyethyl)alkylamine, polyoxyethylene alkylamine, fatty acid glycerin ester, polyoxyethylene glycol fatty acid ester, sorbitan fatty acid ester, polyoxysorbitan fatty acid ester, polyoxyethylene alkyl phenyl ether, polyoxyethylene alkyl ether, polyethylene glycol, polyoxyethylene diamine, copolymers made of polyether, polyester, and polyamide, and methoxypolyethylene glycol(meth)acrylate, etc. These compounds may be used alone or in combination of two or more thereof.

Examples of the conductive polymer include, for example, polyaniline, polypyrrole, and polythiophene, etc.

Examples of the conductive substance include, for example, tin oxide, antimony oxide, indium oxide, cadmium oxide, titanium oxide, zinc oxide, indium, tin, antimony, gold, silver, copper, aluminum, nickel, chromium, titanium, iron, cobalt, copper iodide, and alloys or mixtures thereof.

Examples of the resin components to be used in the antistatic resin and the conductive resin include, for example, general-purpose resins, such as polyester, acrylic, polyvinyl, urethane, melamine, and epoxy. In the case of a polymer-type antistatic agent, the resin component may not be included. In addition, it is also possible to include, as a cross-linking agent, a melamine-based, urea-based, glyoxal-based, or acrylamide-based methylol or alkylol compound in the antistatic resin component.

The antistatic layer is formed, for example, by diluting the antistatic resin, conductive polymer, or conductive resin into a solvent, such as an organic solvent or water and by coating the liquid on a plastic fin to be dried.

Examples of the organic solvent to be used for forming the antistatic layer include, for example, methyl ethyl ketone, acetone, ethyl acetate, tetrahydrofuran, dioxane, cyclohexanone, n-hexane, toluene, xylene, methanol, ethanol, n-propanol, and isopropanol, etc. These solvents may be used alone or in combination of two or more thereof.

The antistatic layer can be appropriately formed by using a publicly-known coating method. Specific examples of the method include, for example, a roll coating method, gravure coating method, reverse coating method, roll brushing method, spray coating metho air knife coating method, impregnation method, and curtain coating method.

The thickness of the antistatic resin layer, conductive polymer, or conductive resin is normally 0.01 μm to 5 μm, and preferably and approximately 0.03 μm to 1 μm.

Examples of the method of vapor-depositing or plating a conductive substance include, for example, a vacuum vapor deposition method, sputtering method, ion plating method, chemical vapor deposition method, spray pyrolysis method, chemical plating method, and electroplating method, etc.

The thickness of the conductive substance is normally 2 nm to 1000 nm, and preferably 5 nm to 500 nm.

The antistatic agents can be appropriately used as the kneading-type antistatic agent. The blend amount of the kneading-type antistatic agent is 20% by mass or less, and preferably 0.05% by mass to 10% by mass, based on the total mass of a plastic film. A method of kneading the agent is not particularly limited, as far as the antistatic agent is uniformly blended into a resin to be used in the plastic film, and, for example, a heating roller, banbury mixer, pressurized kneader, twin-screw kneader, etc., are used.

In order to protect the pressure-sensitive adhesive surfaces, it is possible to attach a release liner to the pressure-sensitive adhesive sheet according to the present embodiment and the later-described surface protective sheet and optical surface protective sheet, if necessary.

Paper or a plastic film can be used as a material for forming the release liner, but a plastic film is preferably used from the viewpoint of being excellent in surface smoothness. The film is not particularly limited, as far as it can protect the pressure-sensitive adhesive layer. Examples of the film include, for example, a polyethylene film, polypropylene film, polybutene film, polybutadiene film, polymethylpentene film, polyvinylchloride film, vinylchloride copolymer film, polyethylene terephthalate film, polybutylene terephthalate film, polyurethane film, ethylene-vinylacetate copolymer film, etc.

The thickness of the release liner is normally 5 μm to 200 μm, and preferably and approximately 10 μm to 100 μm. When the thickness thereof is within the aforementioned range, the workability for attaching the release liner to the pressure-sensitive adhesive layer and that for peeling therefrom are excellent, and hence the thickness is desired. In addition, the release liner can also be subjected to, if necessary: a mold-release and antifouling treatment using a release agent, such as a silicone release agent, fluorine release agent, long-chain alkyl release agent, or fatty acid amide release agent, and a silica powder; and an antistatic treatment, such as a coating type, kneading type, deposition type, or the like.

The pressure-sensitive adhesive sheet according to the present embodiment has the characteristics that the pressure-sensitive adhesive force at high-speed peeling is small and the adhesive force at at low-speed peeling is sufficiently large to an extent in which a trouble, such as lifting and unintended separation, or the like, is not caused. The pressure-sensitive adhesive force at high-speed peeling of the peelable pressure-sensitive adhesive sheet according to the embodiment can be evaluated by a 180°-peeling pressure-sensitive adhesive force test in which the sheet is peeled at a tensile speed of 30 m/min and at a peeling angle of 180°. The force can be evaluated to be good when the force is 2.5 N/25 mm or smaller. The 180°-peeling pressure-sensitive adhesive force is preferably 2.2 N/25 mm or smaller, and more preferably 2.0 N/25 mm or smaller. The minimum of the 180°-peeling pressure-sensitive adhesive force is not particularly required; however, the minimum is normally 0.1 N/25 mm or larger, and preferably 0.2 N/25 mm or larger. The 180°-peeling pressure-sensitive adhesive force test is performed according to the method and conditions described in the later-described Examples.

The pressure-sensitive adhesive force at low-speed peeling of the pressure-sensitive adhesive sheet according to the present embodiment can be evaluated by a period of time required for the peeling in a constant-load peeling test. The force can be determined to be good if a peeling time is 100 seconds or longer when a constant-load of 1.2 g is applied in the 90°-direction to the pressure-sensitive adhesive sheet having a width of 10 mm and a length of 50 mm. The peeling time in the constant-load peeling test is preferably 300 seconds or longer, and more preferably 400 seconds or longer. The maximum of the peeling time in the constant-load peeling test is not particularly required; however, the maximum is normally 1500 seconds or shorter. The constant-load peeling test is performed according to the method and detailed conditions described in the later-described Examples.

The pressure-sensitive adhesive sheet according to the present embodiment has the characteristic that the transparency thereof is high. The transparency of the sheet can be evaluated by a haze. The transparency is determined to be good when a haze is less than 7.3%. The haze is preferably less than 5%, and more preferably less than 3.5%. A haze measurement is performed according to the method and detailed conditions described in the later-described Examples.

The pressure-sensitive adhesive sheet according to the present embodiment has the aforementioned characteristics, and can be used as a peelable pressure-sensitive adhesive sheet and an antistatic pressure-sensitive adhesive sheet by particularly exerting the peelability and antistatic property thereof. The pressure-sensitive adhesive sheet according to the embodiment can be further used as a surface protective sheet, and in particular, as a surface protective sheet to be used in order to protect the surfaces of optical members, such as a polarizing plate, wavelength plate, optical compensation film, and reflective sheet, by further exerting the characteristics. The pressure-sensitive adhesive sheet can also be used as an optical film with a surface protective sheet in which the optical surface protective sheet is attached the optical member.

### [Surface Protective Sheet]

Because the pressure-sensitive adhesive sheet according to the present embodiment has the characteristics that the pressure-sensitive adhesive force at high-speed peeling is small and the adhesive force at low-speed peeling is large to an extent in which a trouble, such as lifting and unintended separation, or the like, is not caused, as described above, it is desirable to use the pressure-sensitive adhesive sheet as surface protective sheets for protecting the surfaces of various objects to be protected. Examples of the objects to be protected by the surface protective sheet according to the embodiment include automobiles (coatings on their bodies), house and building materials, and home electronic appliances, etc., in which members made: of various resins, such as PE (polyethylene), PP (polypropylene), ABS (acrylonitrile-butadiene-styrene copolymer), SBS (styrene-butadiene-styrene block copolymer), PC (polycarbonate), PVC (vinyl chloride), and acrylic resins including PMMA (polymethyl methacrylate resin), etc.; metals, such as SUS (stainless steel) and aluminum; and glass, etc., are used.

When the pressure-sensitive adhesive sheet according to the present embodiment is used as a surface protective sheet, the aforementioned peelable pressure-sensitive adhesive sheet can be used as it is. However, when it is particularly used as a surface protective sheet, it is desirable to use, as the supporting body, a polyolefin film, polyester film, or polyvinylchloride film, each having a thickness of 10 μm to 100 μm, from the viewpoint of prevention of a scratch and a blot and processability. It is also desirable to set the thickness of the pressure-sensitive adhesive layer to be approximately 3 μm to 60 μm.

### [Optical Surface Protective Sheet]

Because the surface protective sheet according to the present embodiment further has the characteristic that the transparency thereof is high, in addition to the pressure-sensitive adhesive characteristics, it is desirable to use the sheet as an optical surface protective sheet. Examples of the optical films to which the optical surface protective film according to the embodiment can be applied include a polarizing plate, wavelength plate, optical compensation film, light diffusion sheet, reflective sheet, anti-reflection sheet, brightness enhancement film, and transparent conductive film (ITO film), etc., each of which is used in image display apparatuses, such as a liquid crystal display, plasma display, and organic EL display.

The optical surface protective film according to the present embodiment can be used in the applications in which: optical films, such as the aforementioned polarizing plate, are protected when they are shipped in manufacturers of the optical films: optical films are protected in the manufacturing processes of display devices (liquid crystal modules) in manufacturers of image display apparatuses, such as liquid crystal apparatuses; and optical films are protected in various steps where, the optical films are punched or cut.

When the peelable pressure-sensitive adhesive sheet according to the present embodiment is used as an optical surface protective sheet, the aforementioned peelable pressure-sensitive adhesive sheet can be used as it is. However, when it is particularly used as an optical surface protective sheet, it is desirable to use, as the supporting body, a polyolefin film, polyethylene terephthalate film, polybutylene terephthalate film, or polyethylene naphthalate film, each having a thickness of 10 μm to 100 μm, from the viewpoint of prevention of a scratch and a blot and processability. It is also desirable to set the thickness of the pressure-sensitive adhesive to be approximately 3 μm to 40 μm.

[Optical Film with Surface Protective Sheet]

In the present embodiment, an optical film with a surface protective sheet in which the optical surface protective sheet is attached to the aforementioned optical film. The optical film with a surface protective sheet according to the present embodiment is obtained by attaching the aforementioned optical surface protective sheet to one or both surfaces of the optical film. By the optical film with a surface protective sheet according to the embodiment, occurrence of a scratch or adherence of dirt and dust can be prevented when: optical films, such as the aforementioned polarizing plate, are shipped in manufacturers of the optical films: display devices (liquid crystal modules) are manufactured in manufacturers of image display apparatuses, such as liquid crystal apparatuses; and optical films are in various steps where the optical films are punched or cut. Further, because the transparency of the optical surface protective sheet is high, the sheet can be inspected as it is. Furthermore, when the optical surface protective sheets become unnecessary, the sheets can be easily peeled without damaging the optical films or the image display apparatuses.

As described above, the pressure-sensitive adhesive composition according to the present embodiment comprises: 100 parts by mass of the polymer (A) having a glass transition temperature lower than 0° C., as a pressure-sensitive adhesive composition; and 0.05 parts by mass to 3 parts by mass of the (meth)acrylic polymer (B) having a weight average molecular weight (MwB) of 1000≦MwB<30000 and including, as a monomer unit, a (meth)acrylic monomer, and hence when a pressure-sensitive adhesive layer is formed by using the pressure-sensitive adhesive composition, the pressure-sensitive adhesive force at high-speed peeling can be made small; the adhesive force at low-speed peeling can be made large to an extent in which a trouble, such as lifting and unintended separation, or the like, is not caused; and in particular, the transparency thereof can be improved. Further, by using the ionic compound (C) and the compound (D) having a polyoxyalkylene chain in combination, an excellent antistatic property can be exhibited.

Because of these excellent characteristics, the peelable pressure-sensitive adhesive sheet, in which a pressure-sensitive adhesive layer made of the pressure-sensitive adhesive composition according to the present embodiment is provided on the supporting body, can be used as a surface protective film, and in particular, can be preferably used as a surface protective film for optical film to be used for protecting the surfaces of optical films. The sheet can also be used as an optical film with a surface protective sheet in which the optical surface protective film is attached to an optical film.

The reasons for the peelable pressure-sensitive adhesive sheet to have the characteristics that: when an adherend not subjected to an antistatic treatment is peeled, prevention of the static electricity and suppression of a peeling-charged electrostatic potential can be achieved; and without the transparency thereof being decreased, the pressure-sensitive adhesive force at high-speed peeling can be made small and the adhesive force at low-speed peeling can be made large to an extent in which a trouble, such as lifting and unintended separation, or the like, is not caused, can be assumed in the following way: by using in combination the ionic compound and the compound having a polyoxyalkylene chain that enhances the conductivity, and by adding a (meth)acrylic polymer containing, as a monomer unit, a (meth)acrylic monomer having an alicyclic structure, and by making the addition amount thereof to be small, interface adhesiveness, having a large influence on the pressure-sensitive adhesive force at low-speed peeling, can be enhanced without changing the physical properties having a large influence on the pressure-sensitive adhesive force at high-speed peeling.

### EXAMPLES

Hereinafter, the present invention will be described in detail based on Examples, but the invention should not be limited at all by Examples.

The components of the pressure-sensitive adhesive compositions of Examples 1 to 13 and Comparative Examples 1 to 5 are shown in Table 2.

TABLE 2

| | | | (METH)ACRYLIC POLYMER (B) | | | | | |
|---|---|---|---|---|---|---|---|---|
| | POLYMER (A) | | | | | NUMBER | IONIC COMPOUND (C) | |
| | COMPOSITION | NUMBER | | | | OF | | NUMBER |
| | (wt %) | OF PARTS | COMPOSITION (wt %) | Mw | Tg (° C.) | PARTS | NAME | OF PARTS |
| EXAMPLE 1 | 2EHA/HEA = | 100 | DCPMA/MMA = | 300 | 130 | 1 | LiTFSI | 0.03 |
| | 96/4 | | 40/60 | | | | | |
| EXAMPLE 2 | 2EHA/HEA = | 100 | DCPMA/MMA = | 4300 | 130 | 1 | LiTFSI | 0.03 |
| | 96/4 | | 40/60 | | | | | |
| EXAMPLE 3 | 2EHA/HEA = | 100 | DCPMA/MMA = | 4300 | 130 | 1 | CIL-312 | 0.35 |
| | 96/4 | | 40/60 | | | | | |
| EXAMPLE 4 | 2EHA/HEA = | 100 | DCPMA/MMA = | 4300 | 130 | 1 | IL-110 | 0.35 |
| | 96/4 | | 40/60 | | | | | |
| EXAMPLE 5 | 2EHA/HEA = | 100 | DCPMA/MMA = | 4300 | 130 | 1 | IL-120 | 0.35 |
| | 96/4 | | 40/60 | | | | | |
| EXAMPLE 6 | 2EHA/HEA = | 100 | DCPMA/MMA = | 4300 | 130 | 1 | IL-220 | 0.35 |
| | 96/4 | | 40/60 | | | | | |
| EXAMPLE 7 | 2EHA/HEA = | 100 | DCPMA/MMA = | 4300 | 130 | 1 | LiTFSI | 0.06 |
| | 96/4 | | 40/60 | | | | | |
| EXAMPLE 8 | 2EHA/HEA = | 100 | DCPMA/MMA = | 4300 | 130 | 2 | LiTFSI | 0.06 |
| | 96/4 | | 40/60 | | | | | |
| EXAMPLE 9 | 2EHA/HEA = | 100 | DCPMA/MMA = | 4300 | 130 | 1 | LiTFSI | 0.06 |
| | 96/4 | | 40/60 | | | | | |
| EXAMPLE 10 | 2EHA/HEA = | 100 | DCPMA/MMA = | 4300 | 130 | 1 | LiTFSI | 0.06 |
| | 96/4 | | 40/60 | | | | | |
| EXAMPLE 11 | 2EHA/HEA = | 100 | IBXMA/MMA = | 4300 | 130 | 1 | LiTFSI | 0.06 |
| | 96/4 | | 40/60 | | | | | |
| EXAMPLE 12 | 2EHA/HEA = | 100 | CHMA/IBMA = | 4000 | 59 | 1 | LiTFSI | 0.06 |
| | 96/4 | | 60/40 | | | | | |
| EXAMPLE 13 | 2EHA/HEA = | 100 | DCPMA/NVP | 24000 | 117 | 1 | LiTFSI | 0.06 |
| | 96/4 | | 60/40 | | | | | |
| COMPARATIVE | 2EHA/HEA = | 100 | — | — | — | — | LiTFSI | 0.06 |
| EXAMPLE 1 | 96/4 | | | | | | | |
| COMPARATIVE | 2EHA/HEA = | 100 | DCPMA/MMA = | 4300 | 130 | 1 | — | — |
| EXAMPLE 2 | 96/4 | | 40/60 | | | | | |
| COMPARATIVE | 2EHA/HEA = | 100 | DCPMA/MMA = | 4300 | 130 | 1 | LiTFSI | 0.36 |
| EXAMPLE 3 | 96/4 | | 40/60 | | | | | |
| COMPARATIVE | 2EHA/HEA = | 100 | DCPMA/MMA = | 4300 | 130 | 5 | LiTFSI | 0.06 |
| EXAMPLE 4 | 96/4 | | 40/60 | | | | | |
| COMPARATIVE | 2EHA/HEA = | 100 | MMA = 100 | 4400 | 105 | 1 | LiTFSI | 0.06 |
| EXAMPLE 5 | 96/4 | | | | | | | |

| | | | CROSS- | CROSS- | | THICKNESS OF |
|---|---|---|---|---|---|---|
| | | | LINKING | LINKING | | PRESSURE- |
| | COMPOUND (D) HAVING | | AGENT | CATALYST | GEL | SENSITIVE |
| | POLYOXYALKYLENE CHAIN | | NUMBER | NUMBER | FRACTION | ADHESIVE |
| | NAME | NUMBER OF PARTS | OF PARTS | OF PARTS | (%) | LAYER (μM) |
| EXAMPLE 1 | KF6004 | 0.5 | 1.5 | 0.03 | 91.6 | 15 |
| EXAMPLE 2 | KF6004 | 0.5 | 2.5 | 0.03 | 93.8 | 15 |
| EXAMPLE 3 | KF6004 | 0.5 | 2.5 | 0.03 | 92.2 | 15 |
| EXAMPLE 4 | KF6004 | 0.5 | 2.5 | 0.03 | 93.5 | 15 |
| EXAMPLE 5 | KF6004 | 0.5 | 2.5 | 0.03 | 92.5 | 15 |
| EXAMPLE 6 | KF6004 | 0.5 | 2.5 | 0.03 | 93.8 | 15 |
| EXAMPLE 7 | KF6004 | 0.5 | 2.5 | 0.03 | 93.4 | 15 |
| EXAMPLE 8 | KF6004 | 0.5 | 2.5 | 0.03 | 91.7 | 15 |
| EXAMPLE 9 | GP-3000 | 0.5 | 2.5 | 0.03 | 93.9 | 15 |
| EXAMPLE 10 | 50HB- | 0.5 | 2.5 | 0.03 | 93.7 | 15 |
| | 2000 | | | | | |
| EXAMPLE 11 | KF6004 | 0.5 | 2.5 | 0.03 | 92.6 | 15 |
| EXAMPLE 12 | KF6004 | 0.5 | 2.5 | 0.03 | 91.8 | 15 |
| EXAMPLE 13 | KF6004 | 0.5 | 2.5 | 0.03 | 92.3 | 15 |
| COMPARATIVE | KF6004 | 0.5 | 2.5 | 0.03 | 94.4 | 15 |
| EXAMPLE 1 | | | | | | |
| COMPARATIVE | CC-42 | 1 | 2.5 | 0.03 | 93.7 | 15 |
| EXAMPLE 2 | | | | | | |
| COMPARATIVE | KF6004 | 3 | 2.5 | 0.03 | 91.3 | 15 |
| EXAMPLE 3 | | | | | | |
| COMPARATIVE | KF6004 | 0.5 | 2.5 | 0.03 | 89.3 | 15 |
| EXAMPLE 4 | | | | | | |
| COMPARATIVE | KF6004 | 0.5 | 2.5 | 0.03 | 92.1 | 15 |
| EXAMPLE 5 | | | | | | |

The abbreviations in Table 2 represent the following compounds.

2EHA: 2-Ethylhexyl Acrylate

HEA: 2-Hydroxyethyl Acrylate

DCPMA: Dicyclopentanyl Methacrylate

MMA: Methyl Methacrylate

NVP: N-Vinyl-2-Pyrrolidone

IBXMA: Isobornyl Methacrylate

CHMA: Cyclohexyl Methacrylate

IBMA: Isobutyl Methacrylate

### (Adjustment of (Meth)Acrylic Polymer (a) (2EHA/HEA=96/4))

Into a four-necked flask equipped with a stirring blade, thermometer, nitrogen gas inlet pipe, cooler, and dropping funnel, 96 parts by mass of 2-ethylhexyl acrylate (2EHA), and 4 parts by mass of 2-hydroxyethyl acrylate (HEA), 0.2 parts by mass of 2,2′-azobisisobutyronitrile as a polymerization initiator, and 150 parts by mass of ethyl acetate were put, and nitrogen gas was introduced while they were being stirred. While the liquid temperature in the flask was being maintained at appropriately 65° C., a polymerization reaction was performed for 6 hours to prepare the acrylic polymer (A) solution (40% by mass). The glass transition temperature of this acrylic polymer (A), calculated from Fox Equation, was −68° C. and the weight average molecular weight thereof was 550,000.

### (Preparation of (Meth)Acrylic Polymer 1 (DCPMA/MMA=40/60) as (B) Component)

Into a four-necked flask equipped with a stirring blade, thermometer, nitrogen gas inlet pipe, cooler, and dropping funnel, 100 parts by mass of toluene, 40 parts by mass of dicyclopentanyl methacrylate (DCPMA) (product name: FA-513M, made by Hitachi Chemical Co., Ltd.), 60 parts by mass of methyl methacrylate (MMA), and 3.5 parts by mass of methyl thioglycolate as a chain transfer agent, were put. After they were stirred under a nitrogen atmosphere at 70° C. for 1 hour, 0.2 parts by mass of azobisisobutyronitrile were put therein as a thermal polymerization initiator to react with them at 70° C. for 2 hours. Thereafter, they were reacted together at 80° C. for 4 hours and were further reacted together at 90° for 1 hour. The glass transition temperature of the obtained (meth)acrylic polymer 1, calculated from Fox Equation, was 130° C. and the weight average molecular weight thereof was 4,300.

### (Preparation of (Meth)Acrylic Polymer 2 (IBXMA/MMA=40/60) as (B) Component)

Into a four-necked flask equipped with a stirring blade, thermometer, nitrogen gas inlet pipe, cooler, and dropping funnel, 100 parts by mass of toluene, 40 parts by mass of isobornyl methacrylate (IBXMA), 60 parts by mass of methyl methacrylate (MMA), and 3 parts by mass of a thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator. Thereafter, they were reacted together at 70° C. for 2 hours and were further reacted together at 80° C. for 2 hours. The glass transition temperature of the obtained (meth)acrylic polymer 2, calculated from Fox Equation, was 130° C. and the weight average molecular weight thereof was 4,300.

### (Preparation of (Meth)Acrylic Polymer 3 (CHMA/IBMA=60/40) as (B) Component)

Into a four-necked flask equipped with a stirring blade, thermometer, nitrogen gas inlet pipe, cooler, and dropping funnel, 60 parts by mass of cyclohexyl methacrylate (CHMA), 40 parts by mass of isobutyl methacrylates (IBMA), and 4 parts by mass of a thioglycolic acid as a chain transfer agent, were put. After they were stirred under a nitrogen atmosphere at 70° C. for 1 hour, they were heated to 90° C. and 0.005 parts by mass of “PERHEXYL O” (made by NOF CORPORATION) and 0.01 parts by mass of “PERHEXYL D” (made by NOF CORPORATION) were mixed as thermal polymerization initiators. After they were stirred at 90° C. for 1 hour, they were heated to 150° C. in 1 hour to be stirred at the temperature for 1 hour. Subsequently, they were heated to 170° C. in 1 hour to be stirred at the temperature for 60 minutes. They were then left under a reduced pressure at 170° C. and a remaining monomer was removed by stirring for 1 hour to obtain a (meth)acrylic polymer 3. The glass transition temperature of the obtained (meth)acrylic polymer 3, calculated from Fox Equation, was 59° C. and the weight average molecular weight thereof was 4,000.

### (Preparation of (Meth)Acrylic Polymer 4 (DCPMA/NVP=60/40) as (B) Component)

Into a four-necked flask equipped with a stirring blade, thermometer, nitrogen gas inlet pipe, cooler, and dropping funnel, 100 parts by mass of toluene, 60 parts by mass of dicyclopentanyl methacrylate (DCPMA) (product name: FA-513M, made by Hitachi Chemical Co., Ltd.), 40 parts by mass of N-vinyl pyrrolidone (NVP), and 2 parts by mass of a thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator. After they were stirred under a nitrogen atmosphere at 70 C for 1 hour, 0.2 parts by mass of azobisisobutyronitrile were put therein as a thermal polymerization initiator. Thereafter, they were reacted together at 70° C. for 2 hours and were further reacted together at 80° C. for 2 hours. Subsequently, the reaction liquid was put under a temperature atmosphere of 130° C. to dry and remove the toluene, chain transfer agent, and unreacted monomer, thereby allowing a solid (meth)acrylic polymer 4 to be obtained. The glass transition temperature of the obtained (meth)acrylic polymer 4, calculated from Fox Equation, was 117° C. and the weight average molecular weight thereof was 24,000.

### (Preparation of (Meth)Acrylic Polymer 5 (MMA=100) as (B) Component)

Into a four-necked flask equipped with a stirring blade, thermometer, nitrogen gas inlet pipe, cooler, and dropping funnel, 100 parts by mass of toluene, 100 parts by mass of methyl methacrylate (MMA), and 3 parts by mass of a thioglycolic acid as a chain transfer agent, were put. After they were stirred under a nitrogen atmosphere at 70° C. for 1 hour, 0.2 parts by mass of azobisisobutyronitrile were put therein as a thermal polymerization initiator. Thereafter, they were reacted together at 70° C. for 2 hours and were further reacted together at 80° C. for 4 hours. The glass transition temperature of an obtained (meth)acrylic polymer 5, calculated from Fox Equation, was 105° C. and the weight average molecular weight thereof was 4,400.

### Example 1

### Preparation of Pressure-Sensitive Adhesive Composition

To 500 parts by mass of a solution (100 parts by mass of the (meth)acrylic polymer (a)) in which a (meth)acrylic polymer (a) solution (35% by mass) was diluted to 20% by mass with ethyl acetate, 1 part by mass of the (meth)acrylic polymer 1, 0.03 parts by mass of bis(trifluoromethanesulfonyl)imide lithium (product name: LiTFSI, made by Tokyo Chemical Industry Co., Ltd.) as the ionic compound, 0.5 parts by mass of organopolysiloxane having a polyoxyalkylene chain (product name: KF6004, made by Shin-Etsu Chemical Co., Ltd.) as the compound having a polyoxyalkylene chain, 2.0 parts by mass of Coronate L (75% by mass ethyl acetate solution of a solid of trimethylolpropane/tolylene diisocyanate trimer adduct, made by Nippon Polyurethane Industry Co., Ltd) as a cross-linking agent, and 3 parts by mass of 1% by mass ethyl acetate solution of a solid as a cross-linking catalyst, were added. A pressure-sensitive adhesive composition (1) was prepared by mixing and stirring the above mixture at 25° C. for approximately 5 minutes.

### (Production of Pressure-Sensitive Adhesive Sheet)

After the aforementioned pressure-sensitive adhesive composition (1) was coated on a surface of a polyethylene terephthalate film with an antistatic treated layer (product name: Diafoil T100G38, made by Mitsubishi Plastics Inc., thickness: 38 μm), the surface being opposite to an antistatic treated surface, the coated composition was heated at 130° C. for 2 minutes to form a pressure-sensitive adhesive layer having a thickness of 15 μm. Subsequently, a release liner (a polyethylene terephthalate film having a thickness of 25 μm whose one surface has been subjected to a silocone treatment) was attached to the surface of the aforementioned pressure-sensitive adhesive layer, thereby allowing a pressure-sensitive adhesive sheet to be produced.

### Example 2

### Preparation of Pressure-Sensitive Adhesive Composition

A pressure-sensitive adhesive composition (2) was prepared in the same way as that in Example 1, except that 3.3 parts by mass of the Coronate L (75% by mass ethyl acetate solution of a solid of trimethylolpropane/tolylene diisocyanate trimer adduct, made by Nippon Polyurethane Industry Co., Ltd) were used instead of 2.0 parts by mass of the Coronate L.

### (Production of Pressure-Sensitive Adhesive Sheet)

A pressure-sensitive adhesive sheet was produced in the same way as that in Example 1, except that the aforementioned pressure-sensitive adhesive composition (2) was used instead of the pressure-sensitive adhesive composition (1).

### Example 3

### Preparation of Pressure-Sensitive Adhesive Composition

A pressure-sensitive adhesive composition (3) was prepared in the same way as that in Example (2), except that 0.35 parts by mass of 1-butyl-3-methylpyridinium bis(trifluoromethanesulfonyl)imide (product name: CIL-312, made by Japan Carlit Co., Ltd., liquid at 25° C.) were used instead of 0.03 parts by mass of the bis(trifluoromethanesulfonyl)imide lithium (product name: LiTFSI, made by Tokyo Chemical Industry Co., Ltd.).

### (Production of Pressure-Sensitive Adhesive Sheet)

A pressure-sensitive adhesive sheet was produced in the same way as that in Example (1), except that the pressure-sensitive adhesive composition (3) was used instead of the pressure-sensitive adhesive composition (1).

### Example 4

### Preparation of Pressure-Sensitive Adhesive Composition

A pressure-sensitive adhesive composition (4) was prepared in the same way as that in Example 2, except that 0.35 parts by mass of 1-ethyl-3-methylimidazolium bis(fluorosulfonyl)imide (product name: IL-110, made by DAI-ICHI KOGYO SEIYAKU CO., LTD.) were used instead of 0.03 parts by mass of the bis(trifluoromethanesulfonyl)imide lithium (product name: LiTFSI, made by Tokyo Chemical Industry Co., Ltd.).

### (Production of Pressure-Sensitive Adhesive Sheet)

A pressure-sensitive adhesive sheet was produced in the same way as that in Example (1), except that the pressure-sensitive adhesive composition (4) was used instead of the pressure-sensitive adhesive composition (1).

### Example 5

### Preparation of Pressure-Sensitive Adhesive Composition

A pressure-sensitive adhesive composition (5) was prepared in the same way as that in Example 2, except that 0.35 parts by mass of 1-methyl-1-propylpyrrolidinium bis(fluorosulfonyl)imide (product name: IL-120, made by DAI-ICHI KOGYO SEIYAKU CO., LTD.) were used instead of 0.03 parts by mass of bis(trifluoromethanesulfonyl)imide lithium (product name: LiTFSI, made by Tokyo Chemical Industry Co., Ltd.).

### (Production of Pressure-Sensitive Adhesive Sheet)

A pressure-sensitive adhesive sheet (5) was produced in the same way as in Example 1, except that the pressure-sensitive adhesive composition (5) was used instead of the pressure-sensitive adhesive composition (1).

### Example 6

### Preparation of Pressure-Sensitive Adhesive Composition

A pressure-sensitive adhesive composition (6) was prepared in the same as that in Example 2, except that 0.35 parts by mass of 1-methyl-1-propylpyrrolidinium bis(trifluoromethanesulfonyl)imide (product name: IL-220, made by DAI-ICHI KOGYO SEIYAKU CO., LTD.) were used instead of 0.03 parts by mass of the bis(trifluoromethanesulfonyl)imide lithium (product name: LiTFSI, made by Tokyo Chemical Industry Co., Ltd.).

### (Production of Pressure-Sensitive Adhesive Sheet)

A pressure-sensitive adhesive sheet was produced in the same way as that in Example 1, except that the pressure-sensitive adhesive composition (6) was used instead of the pressure-sensitive adhesive composition (1).

### Example 7

### Preparation of Pressure-Sensitive Adhesive Composition

A pressure-sensitive adhesive composition (7) was prepared in the same way as that in Example 2, except that 0.06 parts by mass of the bis(trifluoromethanesulfonyl)imide lithium (product name: LiTFSI, made by Tokyo Chemical Industry Co., Ltd.) were used instead of 0.03 parts by mass thereof.

### (Production of Pressure-Sensitive Adhesive Sheet)

A pressure-sensitive adhesive sheet was produced in the same way as that in Example 1, except that the pressure-sensitive adhesive composition (7) was used instead of the pressure-sensitive adhesive composition (1).

### Example 8

### Preparation of Pressure-Sensitive Adhesive Composition

A pressure-sensitive adhesive composition (8) was prepared in the same way as that in Example 7, except that 2 parts by mass of the (meth)acrylic polymer 1 were used instead of 1 part by mass thereof.

### (Production of Pressure-Sensitive Adhesive Sheet)

A pressure-sensitive adhesive sheet was produced in the same way as that in Example 1, except that the pressure-sensitive adhesive composition (8) was used instead of the pressure-sensitive adhesive composition (1).

### Example 9

### Preparation of Pressure-Sensitive Adhesive Composition

A pressure-sensitive adhesive composition (9) was prepared in the same way as that in Example 7, except that 0.5 parts by mass of polypropylene glycol (product name: GP-3000, number average molecular weight of 3,000, triol-type, made by Sanyo Chemical Industries, Ltd.) were used instead of 0.5 parts by mass of the organopolysiloxane having a polyoxyalkylene chain (product name: KF6004, made by Shin-Etsu Chemical Co., Ltd.).

### (Production of Pressure-Sensitive Adhesive Sheet)

A pressure-sensitive adhesive sheet was produced in the same way as that in Example 1, except that the pressure-sensitive adhesive composition (9) was used instead of the pressure-sensitive adhesive composition (1).

### Example 10

### Preparation of Pressure-Sensitive Adhesive Composition

A pressure-sensitive adhesive composition (10) was prepared in the same way as that in Example 7, except that 0.5 parts by mass of polyethylene glycol polypropylene glycol (product name: 50HB-2000, number average molecular weight of 2,300, monobutyl ether-type, made by Sanyo Chemical Industries, Ltd.) were used instead of 0.5 parts by mass of the organopolysiloxane having a polyoxyalkylene chain (product name: KF6004, made by Shin-Etsu Chemical Co., Ltd.).

### (Production of Pressure-Sensitive Adhesive Sheet)

A pressure-sensitive adhesive sheet was produced in the same way as that in Example 1, except that the pressure-sensitive adhesive composition (10) was used instead of the pressure-sensitive adhesive composition (1).

### Example 11

### Preparation of Pressure-Sensitive Adhesive Composition

A pressure-sensitive adhesive composition (11) was prepared in the same way as that in Example 7, except that 1 part by mass of the (meth)acrylic polymer 2 was used instead of 1 part by mass of the (meth)acrylic polymer 1.

### (Production of Pressure-Sensitive Adhesive Sheet)

A pressure-sensitive adhesive sheet was produced in the same way as that in Example 1, except that the pressure-sensitive adhesive composition (11) was used instead of the pressure-sensitive adhesive composition (1).

### Example 12

### Preparation of Pressure-Sensitive Adhesive Composition

A pressure-sensitive adhesive composition (12) was prepared in the same way as that in Example 7, except that 1 part by mass of the (meth)acrylic polymer 3 was used instead of 1 part by mass of the (meth)acrylic polymer 1.

### (Production of Pressure-Sensitive Adhesive Sheet)

A pressure-sensitive adhesive sheet was produced in the same way as that in Example 1, except that the pressure-sensitive adhesive composition (12) was used instead of the pressure-sensitive adhesive composition (1).

### Example 13

### Preparation of Pressure-Sensitive Adhesive Composition

A pressure-sensitive adhesive composition (13) was prepared in the same way as that in Example 7, except that 1 part by mass of the (meth)acrylic polymer 4 was used instead of 1 part by mass of the (meth)acrylic polymer 1.

### Comparative Example 1

### Preparation of a Pressure-Sensitive Adhesive Composition

A pressure-sensitive adhesive composition (14) was prepared in the same way as that in Example 7, except that the (meth)acrylic polymer 1 was not used.

### (Production of Pressure-Sensitive Adhesive Sheet)

A pressure-sensitive adhesive sheet was produced in the same way as that in Example 1, except that the pressure-sensitive adhesive composition (14) was used instead of the pressure-sensitive adhesive composition (1).

### Comparative Example 2

### Preparation of Pressure-Sensitive Adhesive Composition

A pressure-sensitive adhesive composition (15) was prepared in the same way as that in Example 7, except that the bis(trifluoromethanesulfonyl)imide lithium (product name: LiTFSI, made by Tokyo Chemical Industry Co., Ltd.) was not used and 1 part by mass of chloride polyoxypropylene methyl diethyl ammonium (product name: Adekacol CC-42, made by ADEKA CORPORATION) was used instead of 0.5 parts by mass of the organopolysiloxane having a polyoxyalkylene chain (product name: KF6004, made by Shin-Etsu Chemical Co., Ltd.).

### (Production of Pressure-Sensitive Adhesive Sheet)

A pressure-sensitive adhesive sheet was produced in the same way as that in Example 1, except that the pressure-sensitive adhesive composition (15) was used instead of the pressure-sensitive adhesive composition (1).

### Comparative Example 3

### Preparation of Pressure-Sensitive Adhesive Composition

A pressure-sensitive adhesive composition (16) was prepare in the same way as that in Example 7, except that 0.36 parts by mass of bis(trifluoromethanesulfonyl)imide lithium (product name: LiTFSI, made by Tokyo Chemical Industry Co., Ltd.) were used instead of 0.06 parts by mass thereof and that 3 parts by mass of the organopolysiloxane having a polyoxyalkylene chain (product name: KF6004, made by Shin-Etsu Chemical Co., Ltd.) were used instead of 0.5 parts by mass thereof.

### (Production of Pressure-Sensitive Adhesive Sheet)

A pressure-sensitive adhesive sheet was produced in the same way as that in Example 1, except that the pressure-sensitive adhesive composition (16) was used instead of the pressure-sensitive adhesive composition (1).

### Comparative Example 4

### Preparation of Pressure-Sensitive Adhesive Composition

A pressure-sensitive adhesive composition (17) was prepared in the same way as that in Example 7, except that 5 parts by mass of the (meth)acrylic polymer 1 were used instead of 1 part by mass thereof.

### (Production of Pressure-Sensitive Adhesive Sheet)

A pressure-sensitive adhesive sheet was produced in the same way as that in Example 1, except that the pressure-sensitive adhesive composition (17) was used instead of the pressure-sensitive adhesive composition (1).

### Comparative Example 5

### Preparation of Pressure-Sensitive Adhesive Composition

A pressure-sensitive adhesive composition (18) was prepared in the same way as that in Example 7, except that 1 part by mass of the (meth)acrylic polymer 5 was used instead of 1 part by mass of the (meth)acrylic polymer (1).

### (Production of Pressure-Sensitive Adhesive Sheet)

A pressure-sensitive adhesive sheet was produced in the same way as that in Example 1, except that the pressure-sensitive adhesive composition (18) was used instead of the pressure-sensitive adhesive composition (1).

### (TestMethod)

### <Measurement of Molecular Weight>

The weight average molecular weights of the polymers and the (meth)acrylic copolymers were determined by using a GPC apparatus (product name: HLG-8220GPC, made by TOSOH CORP.). Measurement conditions were as follows and the molecular weights were determined by standard polystyrene conversion.

*Sample concentration: 0.2 wt % (tetrahydrofuran (THF) solution)

*Sample injection volume: 10 μl

*Eluent: THF

*Flow Rate: 0.6 ml/min

*Measuring temperature: 40° C.

*Column:

Sample column: TSKguardcolumn SuperHZ-H(1 column)+TSKgel SuperHZM-H (2 columns)

Reference column: TSKgel SuperH-RC (1 column)

*Detector: differential refractometer (RI)

Only the (meth)acrylic copolymer 4 (DCPMA/NVP=60/40) was measured in the following conditions.

*Sample concentration: 0.1 wt % (THF/N,N-dimethylformamide (DMF) solution)

*Sample injection volume: 20 μl

*Eluent: 10 mM-LiBr+10 mM-phosphoric acid/DMF

*Flow Rate: 0.4 ml/min

*Measuring temperature: 40° C.

*Column:

Sample column: TSK guardcolumn SuperAW-H(1 column)+TSKgel SuperAWH-H+TSKgel SuperAW4000+TSKgel SuperAW2500

Reference column: TSKgel SuperH-RC (1 column)

*Detector: differential refractometer (RI)

### (Measurement of Ratio of Solvent-Insoluble Component)

A ratio of a solvent-insoluble component was determined in the following way: after 0.1 g of a pressure-sensitive adhesive composition was sampled and precisely weighed (mass before dipping), the sampled composition was dipped in approximately 50 ml of ethyl acetate at room temperature (20 to 25° C.) for 1 week; a solvent (ethyl acetate) insoluble component was taken out to be dried at 130° C. for 2 hours and then weighed (mass after dipping and drying); and the ratio was calculated by using an equation for calculating a “ratio of solvent-insoluble component (% by mass)=[(mass after dipping and drying)/(mass before dipping)]×100”.

### (Low-Speed Peeling Test: Constant-Load Peeling)

After the pressure-sensitive adhesive sheet according to each of Examples and Comparative Examples was cut into a size of 10 mm in width×60 mm in length and the release liner was peeled, the pressure-sensitive adhesive sheet was pressure-bonded to the surface of a triacetyl cellulose polarizing plate (product name: SEG1425DU, width: 70 mm, length: 100 mm, made by NITTO DENKO CORPORATION) with a hand roller and then laminated in a pressure-bonding condition of 0.25 MPa×0.3 m/min, so that an evaluation sample (an optical film with a surface protective sheet) was produced.

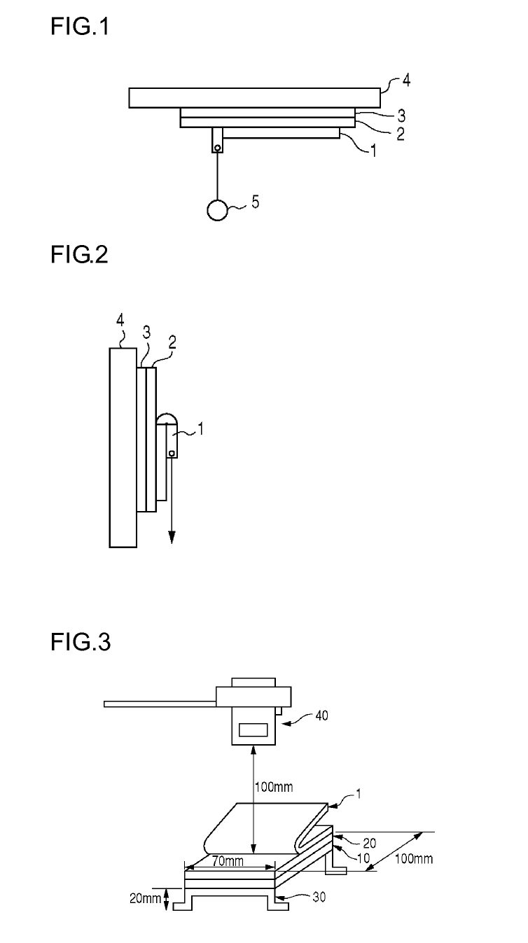

After the lamination, the sample was stored under an environment of 23° C.×50% RH for 30 minutes. Thereafter, a surface of a triacetyl cellulose polarizing plate 2, the surface being opposite to the above surface, was fixed to an acrylic plate 4 with a double-sided pressure-sensitive adhesive tape 3, as illustrated in FIG. 1, and then a constant-load 5 (1.2 g) was fixed to one end portion of a pressure-sensitive adhesive sheet 1. Peeling of the tape sample was initiated with the constant-load such that a peeling angle was 90°. A 10-mm long portion of the tape sample was set to be left, and a period of time, during which all of the remaining 50-mm portion thereof was peeled, was measured. The measurement was performed under an environment of 23° C.×50%. A sample, in which a peeling period of time under the constant-load was 100 second or longer, was evaluated to be good, and a sample, in which the peeling period of time was shorter than 100 seconds, was evaluated to be not good. Results of the measurement are shown in Table 3.

### (High-Speed Peeling Test: 180°-Peeling Pressure-Sensitive Adhesive Force)

After the pressure-sensitive adhesive sheet according to each of Examples and Comparative Examples was cut into a size of 25 mm in width×100 mm in length and the release liner was peeled, the pressure-sensitive adhesive sheet was pressure-bonded to the surface of a triacetyl cellulose polarizing plate (product name: SEG1425DU, width: 70 mm, length: 100 mm, made by NITTO DENKO CORPORATION) with a hand roller and then laminated in a pressure-bonding condition of 0.25 MPa×0.3 m/min, so that an evaluation sample (an optical film with a surface protective sheet) was produced.

After the lamination, the sample was stored under an environment of 23° C.×50% RH for 30 minutes. Thereafter, a surface of a triacetyl cellulose polarizing plate 2, the surface being opposite to the above surface, was fixed to an acrylic plate 4 with a double-sided pressure-sensitive adhesive tape 3, as illustrated in FIG. 2, and then one end portion of a pressure-sensitive adhesive sheet 1 was peeled by a universal testing machine at a tensile speed of 30 m/min and at a peeling angle of 180°. The pressure-sensitive adhesive force occurring at the time was measured. The measurement was performed under an environment of 23° C.×50% RH. A sample, in which a pressure-sensitive adhesive force at high-speed peeling was less than 2.5 N/25 mm, was evaluated to be good, and a sample, in which the pressure-sensitive adhesive force was 2.5 N/25 mm or larger, was evaluated to be not good. Results of the measurement are shown in Table 3.

### <Measurement of Peeling-Charged Electrostatic Potential>

After the pressure-sensitive adhesive sheet 1 was cut into a size of 70 mm in width×130 mm in length and the separator was peeled, the sheet 1 was pressure-bonded to the surface of a polarizing plate 20 (product name: SEG1425DU, width: 70 mm, length: 100 mm, made by NITTO DENKO CORPORATION), which had been attached to an acrylic plate 10 (product name: ACRYLITE, thickness: 1 mm, width: 70 mm, length: 100 mm, made by Mitsubishi Rayon Co., Ltd) that has been neutralized in advance, with a hand roller such that a 30-mm long end portion of the sheet 1 protruded.

After the sample was stored under an environment of 23° C.×50% RH for one day, the sample was set at a predetermined position of a sample fixing table 30, as illustrated in FIG. 3. The one end of the sheet 1, which protruded by 30 mm, was fixed to an automatic winder to peel the sheet 1 at a peeling angle of 150° and a peeling speed of 30 m/min. A potential on the surface of the polarizing plate, occurring at the time, was measured with a potential measurement instrument 40 (product name: KSD-0103, made by KASUGA ELECTRIC WORKS, LTD.) that was fixed to a predetermined position. A measured value was made to be a peeling-charged electrostatic potential. The measurement was performed under an environment of 20° C.×25% RH or 23° C.×50% RH. Under an environment of 20° C.×25% RH, the absolute value of a peeling-charged electrostatic potential is preferably 3.5 kV or less, and more preferably 2.0 kV or less. Under an environment of 23° C.×50% RH, the absolute value thereof is preferably 1.5 kV or less, and more preferably 1.0 kV or less. When the absolute value thereof is within the aforementioned ranges, dust collection by static electricity and a loss of a liquid crystal panel can be prevented, which is useful.

### (Transparency Test: Haze)

After the pressure-sensitive adhesive sheet according to each of Examples and Comparative Examples was cut into a size of 50 mm in width×50 m in length and the release liner was peeled, a haze was measured with a haze meter (made by MURAKAMI COLOR RESEARCH LABORATORY CO., Ltd.). A pressure-sensitive adhesive sheet, in which a haze was less than 7.3%, was evaluated to be good, and a sheet, in which a haze is 7.3% or more, was evaluated to be not good. Results of the measurement are shown in Table 3.

TABLE 3

| | | | PEELING-CHARGED | | |
|---|---|---|---|---|---|
| | | PRESSURE-SENSITIVE | ELECTROSTATIC POTENTIAL | | |
| | CONSTANT-LOAD | ADHESIVE FORCE AT | 20° C./ | 23° C./ | |
| | PEELING TEST | HIGH-SPEED PEELING | 25% RH | 50% RH | HAZE |
| | (SEC) | (N/25 mm) | (kV) | (kV) | (%) |
| EXAMPLE 1 | 687 | 0.87 | 0.0 | 0.0 | 2 |
| EXAMPLE 2 | 626 | 0.54 | −0.2 | 0.0 | 1.9 |
| EXAMPLE 3 | 400 | 0.99 | −0.2 | 0.0 | 2.1 |
| EXAMPLE 4 | 1283 | 0.80 | 0.0 | 0.0 | 2.1 |
| EXAMPLE 5 | 298 | 0.73 | −0.4 | 0.0 | 2.1 |
| EXAMPLE 6 | 307 | 0.55 | −0.2 | 0.0 | 2.2 |
| EXAMPLE 7 | 317 | 0.51 | −0.1 | 0.0 | 2.2 |
| EXAMPLE 8 | 966 | 0.81 | −0.4 | 0.1 | 3.2 |
| EXAMPLE 9 | 291 | 1.85 | −1.0 | −0.5 | 3.2 |
| EXAMPLE 10 | 384 | 2.25 | −1.0 | 1.2 | 3.5 |
| EXAMPLE 11 | 435 | 0.87 | 0.0 | 0.0 | 2.8 |
| EXAMPLE 12 | 280 | 0.61 | 2.5 | 1.0 | 2.2 |
| EXAMPLE 13 | 297 | 0.51 | −1.1 | −0.3 | 7.1 |
| COMPARATIVE | 65 | 0.45 | −0.1 | 0.0 | 2.2 |
| EXAMPLE 1 | | | | | |
| COMPARATIVE | 166 | 1.44 | −2.6 | −2.5 | 3.0 |
| EXAMPLE 2 | | | | | |
| COMPARATIVE | 74 | 0.12 | 0.0 | 0.0 | 5.2 |
| EXAMPLE 3 | | | | | |
| COMPARATIVE | 1401 | 0.56 | −1.8 | 0.0 | 7.5 |
| EXAMPLE 4 | | | | | |
| COMPARATIVE | 237 | 0.26 | 3.5 | −0.2 | 3.2 |
| EXAMPLE 5 | | | | | |

As shown in Table 3, it has been confirmed that: in Comparative Example 1 in which the (meth)acrylic monomer (B) having a weight average molecular weight (MwB) of 1000≦MwB<30000 and including, as a monomer unit, an acrylic monomer having an alicyclic structure is not included, the pressure-sensitive adhesive force at low-speed peeling is not sufficient; in Comparative Example 2 in which the ionic compound (C) is not used, occurrence of a peeling-charged electrostatic potential cannot be suppressed; and in Comparative Example 3 in which 3 parts by mass or more of the compound (D) having a polyoxyalkylene chain are added, the pressure-sensitive adhesive force at low-speed peeling is not sufficient. Also, it has been confirmed that: in Comparative Example 4 in which 3 parts by mass or more of the (meth)acrylic polymer (B) are added, the transparency is not sufficient; and in Comparative Example 5 in which the (meth)acrylic polymer (B) that does not include, as a monomer unit, a (meth)acrylic monomer having an alicyclic structure, occurrence of a peeling-charged electrostatic potential is not sufficient.

In each of Examples, occurrence of a peeling-charged electrostatic potential was suppressed and both high-speed peelability and low-speed peelability were achieved. Further, transparency was good.

The embodiments described above will be summarized below.

(Item 1) A pressure-sensitive adhesive composition comprising: 100 parts by mass of a polymer (A) having a glass transition temperature lower than 0° C.; 0.05 parts by mass to 3 parts by mass of a (meth)acrylic polymer (B) having a weight average molecular weight (MwB) of 1000≦MwB<30000 and including, as a monomer unit, a (meth)acrylic monomer having an alicyclic structure represented by the following general formula (1); 0.005 parts by mass to 1 part by mass of an ionic compound (C); and 0.01 parts by mass to 2.5 parts by mass of a compound (D) having a polyoxyalkylene chain.

CH₂═C(R¹)COOR² (1)

[wherein R¹ is a hydrogen atom or a methyl group and R² is an alicyclic hydrocarbon group having an alicyclic structure.]

[Item 2] The pressure-sensitive adhesive composition according to Item 1, in which, the polymer (A) is a (meth)acrylic polymer (a).

(Item 3) The pressure-sensitive adhesive composition according to Item 1 or Item 2, in which, the alicyclic hydrocarbon group of the (meth)acrylic monomer having an alicyclic structure has a bridged ring structure.

(Item 4) The pressure-sensitive adhesive composition according to any one of Items 1 to 3, in which, a glass transition temperature of the (meth)acrylic polymer (B) is 20° C. to 300° C.

(Item 5) The pressure-sensitive adhesive composition according to any one of Items 1 to 4, in which, the ionic compound is an alkali metal salt and/or an ionic liquid.

(Item 6) The pressure-sensitive adhesive composition according to Item 5, in which, the alkali metal salt is a lithium salt.

(Item 7) The pressure-sensitive adhesive composition according to Item 5, in which, the ionic liquid is any one of a nitrogen-containing onium salt, sulfur-containing onium salt, and phosphorus-containing onium salt.

(Item 8) The pressure-sensitive adhesive composition according to Item 7, in which, the ionic liquid contains one or more types of cations represented by the following general formulae (C1) to (C4).

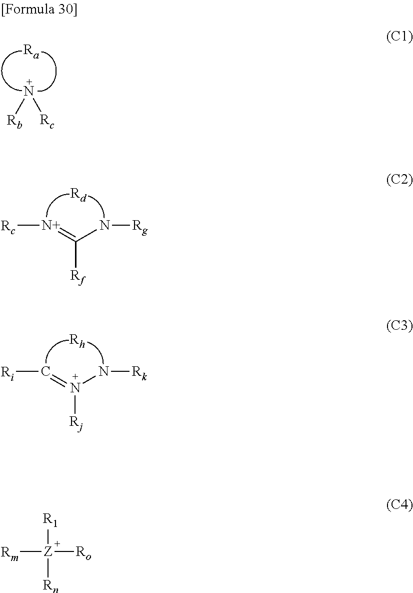

[In the formula (C1), Rₐ represents a C₄₋₂₀ hydrocarbon group and may include a hetero atom; each of R_{b} and Rₑ represents the same or different hydrogen or C₁₋₁₆ hydrocarbon group and may include a hetero atom. However, when the nitrogen atom includes a double bond, Rₘ is not present.]

[In the formula (C2), R_{d} represents a C₂₋₂₀ hydrocarbon group and may include a hetero atom; each of Rₑ, R_{f}, and R_{g} represents the same or different hydrogen or C₁₋₁₆ hydrocarbon group and may include a hetero atom.]

[In the formula (C3), Rₕ represents a C₂₋₂₀ hydrocarbon group and may include a hetero atom; each of Rᵢ, Rⱼ, and Rₖ represents the same or different hydrogen or C₁₋₁₆ hydrocarbon group and may include a hetero atom.]

[In the formula (C4), Z represents a nitrogen atom, sulfur atom, or phosphorus atom; each of Rₗ, Rₘ, Rₘ, and Rₒ represents the same or different C₁₋₂₀ hydrocarbon group and may include a hetero atom. However, when Z is a sulfur atom, Rₗ is not present.]

(Item 9) The pressure-sensitive adhesive composition according to any one of Items 1 to 8, in which, the compound (D) having a polyoxyalkylene chain is organopolysiloxane having a polyoxyalkylene chain represented by the following general formulae (D1) to (D3).

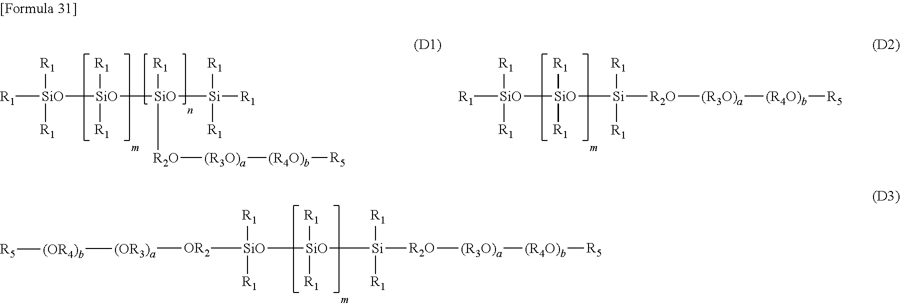

[In the formula (D1), R₁ is a monovalent organic group; each of R₂, R₃, and R₄ is an alkylene group; R₅ is a hydroxyl group or an organic group; each of m and n is an integer of 0 to 1000, however, m and n are not 0 at a time; and each of a and b is an integer of 0 to 1000, however, a and b are not 0 at a time.]

[In the formula (D2), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

[In the formula (D3), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

(Item 10) The pressure-sensitive adhesive composition according to any one of Items 1 to 9, in which, the alicyclic hydrocarbon group of the (meth)acrylic monomer in the (meth)acrylic polymer (B) has a bridged ring structure; the ionic compound (C) is an ionic liquid; and the compound (D) having a polyoxyalkylene chain is organopolysiloxane having a polyoxyalkylene chain.

(Item 11) The pressure-sensitive adhesive composition according to any one of Items 2 to 10, in which, the (meth)acrylic polymer (a) further includes, as a monomer component, a hydroxyl group-containing (meth)acrylic monomer.

(Item 12) The pressure-sensitive adhesive composition according to any one of Items 2 to 11, in which, the (meth)acrylic polymer (a) further includes, as a monomer component, an alkylene oxide group-containing reactive monomer whose average added mole number of oxyalkylene units is 3 to 40, in an amount of 5.0% by mass or less.

(Item 13) A pressure-sensitive adhesive layer made of the pressure-sensitive adhesive composition according to any one of items 1 to 12.

(Item 14) The pressure-sensitive adhesive layer according to Item 13 including 85.00 to 99.95% by mass of a solvent-insoluble component.

(Item 15) A pressure-sensitive adhesive sheet in which the pressure-sensitive adhesive layer according to Item 13 or Item 14 is formed on at least one surface of a supporting body.

(Item 16) The pressure-sensitive adhesive sheet according to Item 15, in which, the supporting body is a plastic film subjected to an antistatic treatment.

(Item 17) A surface protective sheet made of the pressure-sensitive adhesive sheet according to Item 15 or Item 16.

(Item 18) An optical surface protective sheet made of the surface protective sheet according to Item 17, which is used to protect a surface of an optical film.

(Item 18) An optical film with a surface protective sheet in which the optical surface protective sheet according to Item 18 is attached to the optical film.

1. A pressure-sensitive adhesive composition comprising:
100 parts by mass of a polymer (A) having a glass transition temperature lower than 0° C.;
0.05 parts by mass to 3 parts by mass of a (meth)acrylic polymer (B) having a weight average molecular weight (MwB) of 1000≦MwB<30000 and including, as a monomer unit, a (meth)acrylic monomer having an alicyclic structure represented by the following general formula (1);
0.005 parts by mass to 1 part by mass of an ionic compound (C); and
0.01 parts by mass to 2.5 parts by mass of a compound (D) having a polyoxyalkylene chain.
CH₂═C(R¹)COOR² (1)
[wherein R¹ is a hydrogen atom or a methyl group and R² is an alicyclic hydrocarbon group having an alicyclic structure.]

2. The pressure-sensitive adhesive composition according to claim 1, wherein the polymer (A) is a (meth)acrylic polymer (a).

3. The pressure-sensitive adhesive composition according to claim 1, wherein the alicyclic hydrocarbon group of the (meth)acrylic monomer having an alicyclic structure has a bridged ring structure.

4. The pressure-sensitive adhesive composition according to claim 1, wherein a glass transition temperature of the (meth)acrylic polymer (B) is 20° C. to 300° C.

5. The pressure-sensitive adhesive composition according to claim 1, wherein the ionic compound is an alkali metal salt and/or an ionic liquid.

6. The pressure-sensitive adhesive composition according to claim 5, wherein the alkali metal salt is a lithium salt.

7. The pressure-sensitive adhesive composition according to claim 5, wherein the ionic liquid is any one of a nitrogen-containing onium salt, sulfur-containing onium salt, and phosphorus-containing onium salt.

8. The pressure-sensitive adhesive composition according to claim 7, wherein the ionic liquid contains one or more types of cations represented by the following general formulae (C1) to (C4). 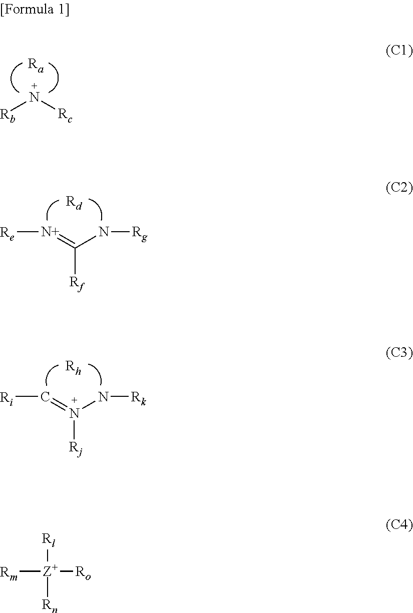
[In the formula (C1), Rₐ represents a C₄₋₂₀ hydrocarbon group and may include a hetero atom; each of R_{b} and Rₑ represents the same or different hydrogen or C₁₋₁₆ hydrocarbon group and may include a hetero atom. However, when the nitrogen atom includes a double bond, Rₑ is not present.]
[In the formula (C2), R_{d} represents a C₂₋₂₀ hydrocarbon group and may include a hetero atom; each of Rₑ, R_{f}, and R_{g} represents the same or different hydrogen or C₁₋₁₆ hydrocarbon group and may include a hetero atom.]
[In the formula (C3), Rₕ represents a C₂₋₂₀ hydrocarbon group and may include a hetero atom; each of Rᵢ, Rⱼ, and Rₖ represents the same or different hydrogen or C₁₋₁₆ hydrocarbon group and may include a hetero atom.]
[In the formula (C4), Z represents a nitrogen atom, sulfur atom, or phosphorus atom; each of Rₗ, Rₘ, Rₙ, and Rₒ represents the same or different C₁₋₂₀ hydrocarbon group and may include a hetero atom. However, when Z is a sulfur atom, Rₒ is not present.]

9. The pressure-sensitive adhesive composition according to claim 1, wherein the compound (D) having a polyoxyalkylene chain is organopolysiloxane having a polyoxyalkylene chain represented by the following general formulae (D1) to (D3). 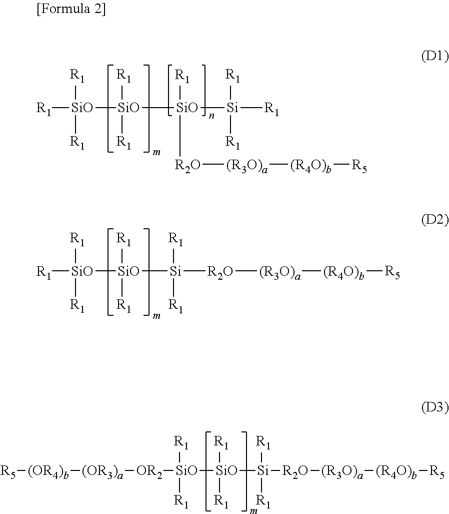
[In the formula (D1), R₁ is a monovalent organic group; each of R₂, R₃, and R₄ is an alkylene group; R₅ is a hydroxyl group or an organic group; each of m and n is an integer of 0 to 1000, however, m and n are not 0 at a time; and each of a and b is an integer of 0 to 1000, however, a and b are not 0 at a time.]
[In the formula (D2), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]
[In the formula (D3), R₁ is a monovalent organic group; each of R₂, R₃, and R₄ is an alkylene group; R₅ is a hydroxyl group or an organic group; m is an integer of 1 to 2000; and each of a and b is an integer of 0 to 1000, however, a and b are not 0 at a time.]

10. The pressure-sensitive adhesive composition according to claim 1, where the alicyclic hydrocarbon group of the (meth)acrylic monomer in the (meth)acrylic polymer (B) has a bridged ring structure; the ionic compound (C) is an ionic liquid; and the compound (D) having a polyoxyalkylene chain is organopolysiloxane having a polyoxyalkylene chain.

11. The pressure-sensitive adhesive composition according to claim 2, wherein the (meth)acrylic polymer (a) further includes, as a monomer component, a hydroxyl group-containing (meth)acrylic monomer.

12. The pressure-sensitive adhesive composition according to claim 2, wherein the (meth)acrylic polymer (a) further includes, as a monomer component, an alkylene oxide group-containing reactive monomer whose average added mole number of oxyalkylene units is 3 to 40, in an amount of 5.0% by mass or less.

13. A pressure-sensitive adhesive layer made of the pressure-sensitive adhesive composition according to claim 1.

14. The pressure-sensitive adhesive layer according to claim 13 including 85.00 to 99.95% by mass of a solvent-insoluble component.

15. A pressure-sensitive adhesive sheet in which the pressure-sensitive adhesive layer according to claim 13 is formed on at least one surface of a supporting body.

16. The pressure-sensitive adhesive sheet according to claim 15, wherein the supporting body is a plastic film subjected to an antistatic treatment.

17. A surface protective sheet made of the pressure-sensitive adhesive sheet according to claim 15.

18. An optical surface protective sheet made of the surface protective sheet according to claim 17, which is used to protect a surface of an optical film.

19. An optical film with a surface protective sheet in which the optical surface protective sheet according to claim 18 is attached to the optical film.

20. The pressure-sensitive adhesive composition according to claim 2, wherein the alicyclic hydrocarbon group of the (meth)acrylic monomer having an alicyclic structure has a bridged ring structure.
